(19) United States
(12) Patent Application Publication
(10) Pub. No.: US 2013/0137841 A1
(43) Pub. Date: May 30, 2013

(54) SELF-ASSEMBLED MULTI-NUCLEAR CATALYST FOR OLEFIN POLYMERIZATION

(71) Applicant: He Kuan Luo, Singapore (SG)

(72) Inventor: He Kuan Luo, Singapore (SG)

(21) Appl. No.: 13/637,362

(22) PCT Filed: Mar. 25, 2011
(86) PCT No.: PCT/SG11/00123

§ 371 Date: Dec. 10, 2012

Related U.S. Application Data
(60) Provisional application No. 61/317,470, filed on Mar. 25, 2010.

(51) Int. Cl. C08F 10/00

(52) U.S. Cl. CPC C08F 10/00
USPC 526/172; 556/34

(57) ABSTRACT

A self-assembled olefin polymerization catalyst comprising a transition metal complex according to formula (I) A-[(L²(MXₙ)ₚ(MXₙ-L¹(MXₙ)_{q}MXₙ—B)ᵣ-MXₙ)_{y}-(L¹(MXₙ)ᵣ(MXₙ-L²(MXₙ)-MXₙ-A′)ᵥMXₙ)w]_{z}-B (I) wherein each M is independently a transition metal selected from the group consisting of Group 3-11 of the periodic table; each X is independently selected from the group consisting of H, halogen, CN, optionally substituted N(R^{a})₂, OH, optionally substituted C₁-C₂₀ alkyl, optionally substituted C₁-C₂₀ alkoxy, wherein R^{a} is independently selected from the group consisting of optionally substituted C₁-C₂₀ alkyl, optionally substituted C₆-C₂₀ aryl and halogen; A is nothing, L¹(MXₙ)_{g}MXₙ—, or MXₙL¹(MXₙ)_{g}MXₙ—; A′ is nothing, -L¹(MXₙ)_{g} MXₙ, or -L¹(MXₙ)_{g}; B is nothing, -L²(MXₙ)h or -L²(MXₙ)ₕMXₙ; g is 0 or an integer of at least 1; h is 0 or an integer of at least 1; p is 0 or an integer of at least 1; q is 0 or an integer of at least 1; r is 0 or an integer of at least 1; t is 0 or an integer of at least 1; u is 0 or an integer of at least 1; v is 0 or an integer of at least 1; w is an integer of at least 1; y is an integer of at least 1; z is an integer of at least 1; n is an integer selected from 0-6, wherein n is selected depending on the valency of M such that the net charge of each M nucleus is zero or all ligand binding positions of M are occupied; L¹ and L² are independently selected ligands, wherein L¹ and L² are different, each of L¹ and L² having at least two linked coordination units, wherein each coordination unit binds to a different transition metal atom.

### CROSS-REFERENCE TO RELATED APPLICATIONS

This application claims the benefit of priority of U.S. provisional application No. 61/317,470, filed Mar. 25, 2010, the contents of it being hereby incorporated by reference in its entirety for all purposes.

### FIELD OF THE INVENTION

The present invention relates to a self-assembled olefin polymerization catalyst, to a process for the polymerization of olefins and to the polyolefins obtained therefrom.

### BACKGROUND OF THE INVENTION

Polyolefins are raw materials used in a wide range of industries, including packaging, automotives and construction. Therefore, the production of polyolefins is a very important branch of industry. The catalysts for olefin polymerization play a key role in the production process, which has led to much work in this area of research.

Amongst the catalysts studied, phenoxy-imine-based Group 4 metal catalysts (see FIG. 1 and Model-1 shown in FIG. 2) have received much attention in both academia and industry because they intrinsically have high activities that compare favorably with that of commercial metallocene or half-sandwich Group 4 metal catalysts. However, this kind of phenoxy-imine-based catalysts has poor stability resulting in limited lifetimes, primarily because of the transfer of supporting ligand to aluminum in the co-catalyst mixture especially under elevated temperatures used in industry. In some cases, the catalysts decay quickly within a matter of minutes. Consequently, these catalysts are usually studied at low temperature and/or short reaction time. This greatly hinders the application of this kind of catalysts in industry. In light of the above, there is substantial incentive to develop robust phenoxy-imine catalysts with high activity and minimal catalyst decay.

As titanium and zirconium catalysts based on phenoxy-imine ligand have limited lifetime, much effort has been made to solve this problem using tetradentate ligands, which were expected to form more stable mono-nuclear catalysts of coordination model-2 (see Model-2 shown in FIG. 2). Studies have shown that the tetradentate ligands of Cₙ-chain-bridged phenoxy-imine units (see II of FIG. 3, n=2-6) form mono-nuclear catalysts. From the results obtained, it can be seen that the ligands of longer bridge (n=5 or 6) displayed high activity for five minutes run, while the ligands of shorter bridge (n=2 to 4) displayed low activity, and the issue of catalyst rapid deactivation was not addressed.

Some research groups believe that the tetradentate ligands incorporating titanium and zirconium may form more stable catalysts bearing the coordination model-2 (see Model-2 in FIG. 2) with two imine-N linked. However, experimental results demonstrated that the tetradentate ligands III and XII (see FIG. 3) did not afford olefin polymerization catalysts, principally because of a destructive 1,2-migratory insertion of a metal-bound alkyl/polymeryl chain into the imine C═N unit. It was found subsequently that introducing an alkyl group at the position R⁴ (see ligand XI shown in FIG. 3) of a zirconium salicylaldiminato complex leads to a long-lived catalyst (1 hour test in toluene) for ethylene polymerization because of steric blocking of an intramolecular 1,2-migratory insertion. However, this steric blocking promotes a new radical catalyst decomposition mechanism in certain instances, thus resulting in far lower activities compared to the corresponding catalyst based on the FI ligand. In addition, all the zirconium complexes of ligands IV-X shown in FIG. 3 have no activity probably due to the lack of steric bulk in the phenolate 2-position.

Further studies on other types of tetradentate ligands were conducted (see XIII-XVII shown in FIG. 3). For titanium complexes, [(XIII)TiCl₂] had no activity for ethylene polymerization when treated with MAO because the two chloride ligands are in trans-arrangement. The cis-complex [(XIV)TiCl₂] was also unproductive, which could be due to enhanced imine reactivity brought on by ring-strain in the diamine backbone. Complex [(XV)TiCl₂] produced only a trace of polymer. Although complexes [(XVI)TiCl₂] and [(XVII)TiCl₂] demonstrated improved activity at 25° C. (in excess of 2×10³ K_{gPE} mol_{cat}⁻¹ h⁻¹ bar⁻¹ for a one hour test), the overall productivities are much lower at 50° C. resulting from a more rapid catalyst decomposition.

For zirconium complexes, complex [(XV)ZrCl₂] produced only a trace of polymer. The complexes [(XVI)ZrCl₂] and [(XVII)ZrCl₂] demonstrated only low activities. Similarly, introducing a methyl group at the phenolate 5-position of the simple phenoxy-imine ligand may block the intramolecular 1,2-migratory insertion, however this steric blocking failed to improve the catalytic lifetime.

A family of multi-nuclear catalysts produced using the process protocol illustrated in FIG. 4 has been developed. A higher activity, better stability and improved lifetime compared to corresponding mono-nuclear catalysts have been demonstrated for this family of multi-nuclear catalysts. For example, good catalytic activities for ethylene homopolymerization to prepare high quality HDPE (High Density Polyethylene) and UHMWPE (Ultra High Molecular Weight Polyethylene), as well as co-polymerization of ethylene with small co-monomers such as propylene have been demonstrated. However, this family of catalysts does not exhibit good performance when they are used to co-polymerize ethylene with higher 1-alkenes such as 1-hexene, thereby limiting their application.

In view of the above, there remains a need for an improved catalyst which has an increased lifetime, a higher activity and which allows polymers with higher molecular weight to be obtained. In particular, there remains a need for an improved catalyst which can be used to co-polymerize ethylene with higher 1-alkenes such as 1-hexene, while exhibiting increased lifetime and a higher activity.

### SUMMARY OF THE INVENTION

In a first aspect the present invention refers to a self-assembled olefin polymerization catalyst comprising a transition metal complex according to formula (I)

A-[(L²(MXₙ)ₚ(MXₙ-L¹(MXₙ)_{q}-MXₙ—B)ᵣ-MXₙ)_{y}-(L¹(MXₙ)ₜ(MXₙ-L²(MXₙ)ᵤ-MXₙ-A′)ᵥMXₙ)_{w}]_{z}—B (I)

wherein
each M is independently a transition metal selected from the group consisting of Group 3-11 of the periodic table;
each X is independently selected from the group consisting of H, halogen, CN, optionally substituted N(R^{a})₂, OH, optionally substituted C₁-C₂₀ alkyl, optionally substituted C₁-C₂₀ alkoxy, wherein R^{a} is independently selected from the group consisting of optionally substituted C₁-C₂₀ alkyl, optionally substituted C₆-C₂₀ aryl and halogen;
A is nothing, L¹(MXₙ)_{g}MXₙ—, or MXₙL¹(MXₙ)_{g}MXₙ—;
A′ is nothing, -L¹(MXₙ)_{g}MXₙ, or -L¹(MXₙ)_{g,};
B is nothing, -L²(MXₙ)ₕ or -L²(MXₙ)ₕMXₙ;
   g is 0 or an integer of at least 1;
   h is 0 or an integer of at least 1;
   p is 0 or an integer of at least 1;
   q is 0 or an integer of at least 1;
   r is 0 or an integer of at least 1;
   t is 0 or an integer of at least 1;
   u is 0 or an integer of at least 1;
   v is 0 or an integer of at least 1;
   w is an integer of at least 1;
   y is an integer of at least 1;
   z is an integer of at least 1;
n is an integer selected from 0-6, wherein n is selected depending on the valency of M such that the net charge of each M nucleus is zero or all ligand binding positions of M are occupied;
L¹ and L² are independently selected ligands, wherein L¹ and L² are different, each of L¹ and L² having at least two linked coordination units, wherein each coordination unit binds to a different transition metal atom.

In a second aspect, the present invention provides a process for polymerization or copolymerization of an olefin or a mixture of olefins in the presence of the self-assembled olefin polymerization catalyst described in the present invention.

In a third aspect, the present invention provides polyolefins obtainable according to the process of the present invention.

### BRIEF DESCRIPTION OF THE DRAWINGS

The invention will be better understood with reference to the detailed description when considered in conjunction with the non-limiting examples and the accompanying drawings, in which:

FIG. 1 illustrates a reaction scheme to produce a mono-nuclear Ti (FI—Ti) and a mono-nuclear Zr (FI—Zr) catalyst from a phenoxy-imine ligand (FI). The mono-nuclear catalysts shown are representative titanium and zirconium catalysts of the prior art based on phenoxy-imine ligand bearing coordination model-1 as shown in FIG. 2.

FIG. 2 illustrates a comparison of three possible coordination models for a catalyst, wherein model-1 (mono-nuclear FI-catalyst) and model-2 (mono-nuclear tetradentate-ligand catalyst) are state of the art and model-3 (multi-nuclear catalyst) illustrates one of the possible coordination models of the present invention.

FIG. 3 illustrates a tetradentate ligand (II) forming model-2 type catalyst as shown in FIG. 2, as well as further tetradentate ligands (III-XVII) forming model-2 type catalyst as shown in FIG. 2.

FIG. 4 illustrates a state of the art self-assembling strategy in order to synthesize olefin polymerization catalysts.

FIG. 5A illustrates a self-assembling strategy in order to synthesize olefin polymerization catalysts according to an embodiment of the present invention, which is carried out in two steps. A bis-ligand (bis-ligand-1) is added to two different metal atoms in a first step to form a bi-nuclear species. The bi-nuclear species react with a second bis-ligand (bis-ligand-2) to form a multi-nuclear self-assembled olefin polymerization catalyst (multi-nuclear catalyst). FIG. 5B illustrates a self-assembling strategy in order to synthesize olefin polymerization catalysts according to another embodiment of the present invention, which is carried out in a single step. A bis-ligand (bis-ligand-1) and a second bis-ligand (bis-ligand-2) are added to two different metal atoms in one single step to form a multi-nuclear self-assembled olefin polymerization catalyst (multi-nuclear catalyst). FIG. 5C illustrates a self-assembling strategy in order to synthesize olefin polymerization catalysts according to a further embodiment of the present invention, which is carried out in one step. As shown, the multi-nuclear self-assembled olefin polymerization catalyst may have a disordered arrangement of the two bis-ligands (bis-ligand-1 and bis-ligand-2), which may be in an alternate or random fashion.

FIG. 6 illustrates the molecular structure of a bis-phenoxy-imine ligand (BFI-3) obtained by single crystal X-ray diffraction. This X-ray structure clearly shows that the distance between the two coordination sites is too long for coordination of one and the same metal atom, therefore the second NO unit will coordinate with a second metal atom to form the self-assembled catalyst.

FIG. 7 illustrates the molecular structure of a bis-phenoxy-imine ligand (BFI-4) obtained by single crystal X-Ray diffraction. As in the case for BFI-3 shown in FIG. 6, this X-ray structure clearly shows that the distance between the two coordination sites is too long for coordination of one and the same metal atom, therefore the second NO unit will coordinate with a second metal atom to form the self-assembled catalyst.

FIG. 8 illustrates the synthesis of self-assembled catalysts MNTi-3 and MNZr-3 using two different bis-phenoxy-imine ligands BFI-1 and BFI-2 in a two step process. Bis-phenoxy-imine ligand BFI-1 is added to two different metal atoms M in a first step to form a bi-nuclear species. The bi-nuclear species react with a second bis-phenoxy-imine ligand BFI-2 to form a multi-nuclear self-assembled olefin polymerization catalyst MNTi-3 or MNZr-3 (wavy lines indicate that the depicted structure can be part of a bigger molecule that contains further repeating units. Alternatively, the wavy lines may represent the remaining, non-depicted part of the respective ligand, with or without a metal atom bound).

FIG. 9 illustrates the synthesis of self-assembled catalysts MNTi-4 and MNTi-5 using two different bis-phenoxy-imine ligands BFI-3 and BPI-1, and BFI-4 and BPI-1 respectively in a two step process. For example, in the case of MNTi-4, bis-phenoxy-imine ligand BFI-3 is added to two different metal atoms M in a first step to form a bi-nuclear species. The bi-nuclear species react with a second bis-phenoxy-imine ligand BPI-1 to form a multi-nuclear self-assembled olefin polymerization catalyst MNTi-4 (wavy lines indicate that the depicted structure can be part of a bigger molecule that contains further repeating units. Alternatively, the wavy lines may represent the remaining, non-depicted part of the respective ligand, with or without a metal atom bound).

FIG. 10 illustrates the synthesis of self-assembled catalysts MNTi-6 and MNZr-6 using two different bis-phenoxy-imine ligands BFI-1 and BFI-2 in a one step process.

FIG. 11 illustrates the synthesis of bis-phenoxy-imine ligand BFI-1 and the corresponding self-assembled catalysts MNTi-1 and MNZr-1.

FIG. 12 illustrates the synthesis of bis-phenoxy-imine ligand BFI-2 and the corresponding self-assembled catalysts MNTi-2 and MNZr-2.

FIG. 13 is a table (Table 1) summarizing the performance of ethylene polymerization obtained using self-assembled polymerization catalysts (MNTi-3 and MNTi-6) according to embodiments of the present invention, and state of the art catalysts (MNTi-1, MNTi-2, and FI—Ti). The polymerization reaction was carried out in a 300 mL stainless steel autoclave, using 100 mL hexane, 5.5 bar of ethylene pressure, 2.0 mmol of methyl aluminoxane (MAO), catalyst loading of 0.9 μmmol metal. Activity of the catalyst is expressed in terms of k_{gPE} mol_{M}⁻¹ h⁻¹ bar⁻¹.

FIG. 14 is a table (Table 2) summarizing the performance of ethylene polymerization obtained using self-assembled polymerization catalysts (MNZr-3 and MNZr-6) according to embodiments of the present invention, and state of the art catalysts (MNZr-1, MNZr-2, and FI—Zr). The polymerization reaction was carried out in a 300 mL stainless steel autoclave, using 100 mL hexane, 5.5 bar of ethylene pressure, 2.0 mmol of methyl aluminoxane (MAO), catalyst loading of 0.09 μmol metal. Activity of the catalyst is expressed in terms of k_{gPE} mol_{M}⁻¹ h⁻¹ bar⁻¹.

FIG. 15 is a graph comparing the amount of polyethylene obtained (PE, g) with time (“productivity comparison”) for MNTi-3 and MNTi-6, and state of the art catalysts MNTi-1, MNTi-2, and FI—Ti.

FIG. 16 is a graph comparing the amount of polyethylene obtained (PE, g) with time (“productivity comparison”) for MNZr-3 and MNZr-6, and state of the art catalysts MNZr-1, MNZr-2, and FI—Zr.

FIG. 17 illustrates the amounts of polymer produced after several reaction times of (i) 30 minutes, (ii) 60 minutes and (iii) 120 minutes using (A) MNTi-3, (B) MNTi-6 and (C) state of the art catalyst FI—Ti. It is shown that for both MNTi-3 and MNTi-6, the amount of polyethylene (PE) increased quickly with an increase in reaction time while for FI—Ti, the amount of polyethylene obtained increased very slowly.

FIG. 18 illustrates the amounts of polymer produced after several reaction times of (i) 5 minutes, (ii) 15 minutes, (iii) 30 minutes, (iv) 60 minutes and (v) 120 minutes using (A) MNZr-3, (B) MNZr-6 and (C) state of the art catalyst FI—Zr. It is shown that for both MNZr-3 and MNZr-6, the amount of polyethylene (PE) increased quickly with an increase in reaction time while for FI—Zr, the amount of polyethylene obtained increased very slowly.

FIG. 19 is a table (Table 3) summarizing the FTIR readings of MNTi-3 and MNZr-3, and state of the art catalysts MNTi-1, MNTi-2, FI—Ti, MNZr-1, MNZr-2, and FI—Zr.

FIG. 20 is a table (Table 4) summarizing the Laser Raman readings of MNTi-3, and state of the art catalysts MNTi-1, MNTi-2, and FI—Ti.

FIG. 21 is a table (Table 5) summarizing the performance of co-polymerization of ethylene and 1-hexene using self-assembled polymerization catalysts (MNTi-4, MNTi-5) according to embodiments of the present invention. The co-polymerization reaction was carried out in a 1 L stainless steel autoclave, using 600 mL of pentane, 6.0 bar of ethylene pressure, varying amounts of 1-hexene and/or hydrogen gas, catalyst loading of 6.0 μmol metal and 6.0 mmol of MAO. Activity of the catalyst is expressed in terms of k_{gPE} mol_{M}⁻¹ h⁻¹ bar⁻¹.

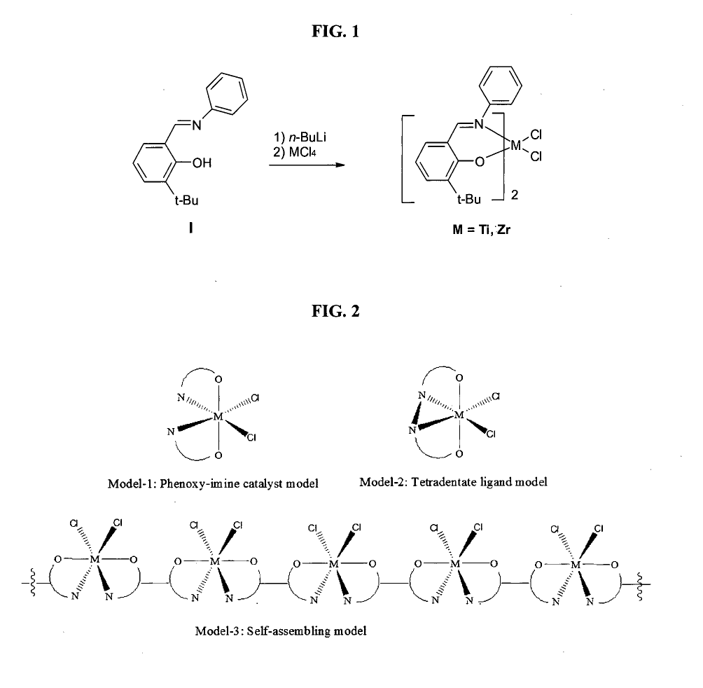

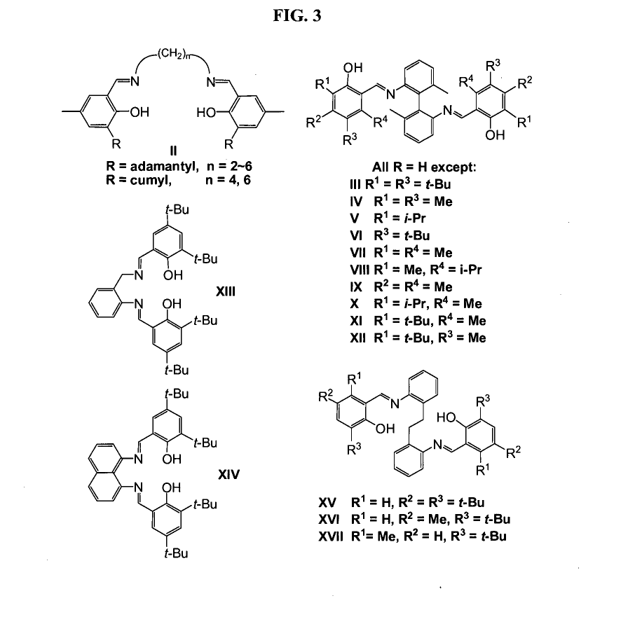

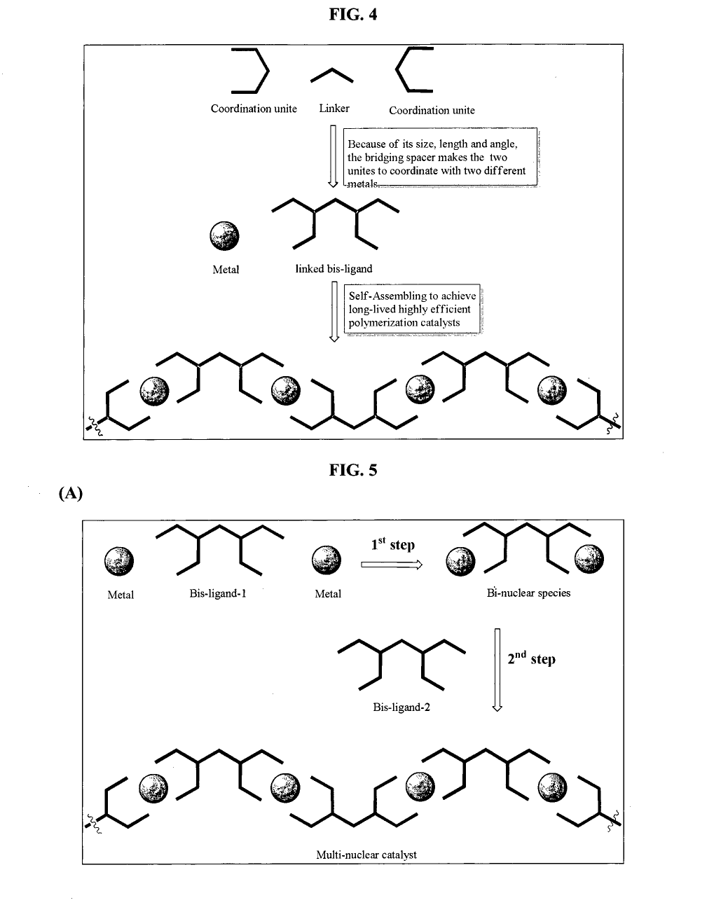

### DETAILED DESCRIPTION OF THE PRESENT INVENTION

In the following description non-limiting embodiments of the process of the invention will be explained.

In a first aspect the present invention refers to a self-assembled olefin polymerization catalyst comprising a transition metal complex according to formula (I)

A-[(L²(MXₙ)ₚ(MXₙ-L¹(MXₙ)_{q}-MXₙ—B)_{q}-MXₙ)_{y}-(L¹(MXₙ)ₜ(MXₙ-L²(MXₙ)ᵤ-MXₙ-A′)ᵥ-MXn)_{w}]_{z}-B (I)

wherein
each M is independently a transition metal selected from the group consisting of Group 3-11 of the periodic table;
each X is independently selected from the group consisting of H, halogen, CN, optionally substituted N(R^{a})₂, OH, optionally substituted C₁-C₂₀ alkyl, optionally substituted C₁-C₂₀ alkoxy, wherein R^{a} is independently selected from the group consisting of optionally substituted C₁-C₂₀ alkyl, optionally substituted C₆-C₂₀ aryl and halogen;
A is nothing, L¹(MXₙ)_{g}MXₙ—, or MXₙ L¹(MXₙ)_{g}MXₙ—;
A′ is nothing, -L¹(MXₙ)_{g}MXₙ, or -L¹(MXₙ)_{g,};
B is nothing, -L²(MXₙ)ₕ or -L²(MXₙ)ₕMXₙ;
   g is 0 or an integer of at least 1;
   h is 0 or an integer of at least 1;
   p is 0 or an integer of at least 1;
   q is 0 or an integer of at least 1;
   r is 0 or an integer of at least 1;
   t is 0 or an integer of at least 1;
   u is 0 or an integer of at least 1;
   v is 0 or an integer of at least 1;
   w is an integer of at least 1;
   y is an integer of at least 1;
   z is an integer of at least 1;
n is an integer selected from 0-6, wherein n is selected depending on the valency of M such that the net charge of each M nucleus is zero or all ligand binding positions of M are occupied;
L¹ and L² are independently selected ligands, wherein L¹ and L² are different, each of L¹ and L² having at least two linked coordination units, wherein each coordination unit binds to a different transition metal atom.

The term “self-assembly” (SA) as used herein refers to processes in which a disordered system of pre-existing components forms an organized structure or pattern as a consequence of specific, local interactions among the components themselves, without external direction. It can be defined as the spontaneous and reversible organization of molecular units into ordered structures by non-covalent interactions.

The transition metal M is selected from the group consisting of Group 3-11 of the periodic table. The transition metal M may be, but is not limited to, Sc, Y, La, Ti, Zr, Hf, V, Nb, Ta, Sm, Yb, Cr, Mo, W, Mn, Tc, Re, Fe, Ru, Os, Co, Rh, Ir, Ni, Pd, Pt, Cu, Zn, or mixtures thereof. In one embodiment of the present invention, M may be Sc, Ti, Zr, Hf, V, Nb, Ta, Sm, Yb, Fe, Co, Rh, Ni or Pd, for example Ti, Zr, Hf, V, Nb, Ta, Sm, Yb, or mixtures thereof. In further embodiments of the present invention, M may be Ti, Zr, or mixtures thereof. In exemplary embodiments of the present invention, M is Ti or Zr. The selection of the respective transition metal atom may depend on the reaction conditions and/or the olefin which should be polymerized.

The transition metal M may be in the oxidation state (O). Alternatively, in another embodiment the oxidation state of the transition metal may be between (I) and (VI) depending on the further type and number of the ligands L¹ and L². For example, M may represent a transition metal atom including, but not limited to, Sc(III), Ti(III), Ti(IV), Zr(III), Zr(IV), Hf(IV), V(III), V(IV), V(V), Nb(V), Ta(V), Fe(II), Fe(III), Co(II), Co(III), Rh(II), Rh(III), Rh(IV), Cr(III), Ni(II), and Pd(II). For example, M may be Ti(IV), Zr(IV), Hf(IV), V(III), V(IV), V(V), Nb(V), and Ta(V); such as Ti(IV), Zr(IV), and Hf(IV). This may mean that M is positively charged and thus is a metal ion.

The number of atoms of the transition metal M present in the self-assembled olefin polymerization catalyst will depend on the number of the ligands L¹ and L² which are present in the self-assembled catalyst. Thus, the number of atoms of the transition metal M may be in the range of about 1 or about 2 to about 1000, for example about 1 to about 100 or about 200 or 300. However, the number of atoms of the transition metal M may also be any other integer being useful in the present invention.

X is a group which is coordinated to the transition metal atom. X may be, but is not limited to, hydrogen, halogen, CN, optionally substituted N(R^{a})₂, OH, optionally substituted C₁-C₂₀ alkyl, or optionally substituted C₁-C₂₀ alkoxy, wherein R^{a} is independently selected from the group consisting of optionally substituted C₁-C₂₀ alkyl, optionally substituted C₆-C₂₀ aryl and halogen. In some embodiments, X may be H, F, Cl, Br, CN, N(CH₃)₂, N(CH₂CH₃)₂, CH₃, CH₂CH₃, OCH₃, OCH₂CH₃, OCH(CH₃)₃, OC(CH₃)₃, or OC₆H₆, and the like. In case multiple X moieties are present, X may be the same or different.

The symbol n in formula (I) represents an integer selected from 0-6, wherein n is selected depending on the valency of the transition metal M such that the net charge of each M nucleus is zero or all ligand binding positions of M are occupied. For example, n may be an integer from about 0-5, such as about 0-4 or about 0-3. Also, n may be 1 or 2. In one embodiment, n is 2 to form an octahedral metal configuration together with the two WY units of each of the ligands L¹ and L². Further metal configurations may be possible depending on n.

In the above formula (I), L¹ and L² are independently selected ligands, wherein L¹ and L² are different i.e. L¹ is not the same ligand as L². Each of ligands L¹ and L² have at least two coordination units which are linked via a spacer Z such that each coordination unit can only bind to a different transition metal atom. This means that, for example, a ligand having two separate coordination units cannot bind to the same transition metal atom with both coordination units. Instead, each coordination unit may bind to a different transition metal atom only.

In the above formula (I), g, h, p, q, r, t, u, and v may independently be 0 or may be an integer of at least 1. The values of g, h, p, q, r, t, u, and v may depend on the number of transition metal atoms in the self-assembled catalyst as well as the number of coordination units present in each of the ligands L¹ and L². For example, g, h, p, q, r, t, u, and v may independently be in the range from about 0 to about 1000, for example about 0 to about 500, about 0 to about 200, or about 0 to about 100. In various embodiments, each g, h, p, q, r, t, u, and v can independently be selected from 0, 1, 2, 3, 4, 5, 6, 7, 8, 9, or 10. However, each g, h, p, q, r, t, u, and v may also be any other integer being useful in the present invention.

In the above formula (I), w, y and z may independently be an integer of at least 1. The values of w, y and z may depend on the number of transition metal atoms in the self-assembled catalyst and the amount of ligands L¹ and L² present. For example, w, y and z may independently be in the range from about 0 to about 1000, for example about 0 to about 500, about 0 to about 200, or about 0 to about 100. In various embodiments, w, y and z are independently 1, 2, 3, 4, 5, 6, 7, 8, 9, 10, 11, 12, 15, 20, 25, 30, 35, 40, 45, or 50. However, w, y and z may also be any other integer being useful in the present invention.

In the above formula (I), A, A′ and B are end groups of the complex. A may be nothing, L¹(MXₙ)_{g}MXₙ—, or MXₙL¹(MXₙ)_{g}MXₙ—. A′ may be nothing, -L¹(MXₙ)_{g}MXₙ, or -L¹ (MXₙ)_{g}. B may be nothing, -L²(MXₙ)ₕ or -L²(MXₙ)ₕMXₙ.

L¹ and L² may independently be a ligand according to formula (II)

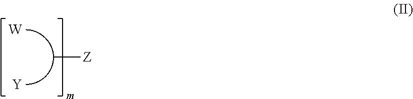

wherein

each WY unit forms a coordination unit;

m is an integer of at least 2;

Z is a bridging spacer selected from the group consisting of optionally substituted hydrocarbons having about 2 to about 100 carbon atoms and optionally substituted hetero-hydrocarbons having about 2 to about 100 carbon atoms, wherein Z has a size, length and angle so that each coordination unit WY binds to a different transition metal atom;

each W and Y is independently a metal-coordinating moiety selected from the group consisting of a carbene, an optionally substituted C₅-C₂₀ aryl, and metal-coordinating groups comprising an oxygen atom, a sulphur atom, a selenium atom, a nitrogen atom, or a phosphorus atom in neutral or charged form;

wherein the semi-circle in the WY unit represents an optionally substituted hydrocarbon, hetero-hydrocarbon or Si-containing backbone to which the metal-coordinating moieties W and Y are bonded.

In various embodiments, the metal-coordinating group is one of an oxygen atom, a sulphur atom, a selenium atom, a nitrogen atom, or a phosphorus atom, preferably in negatively charged form. The afore-mentioned atoms can be part of a larger group or can be bound to another atom or group, including, but not limited to hydrogen

Each of the ligands L¹ and L² may be prepared according to the process described below.

In the above formula (II), m may be 2, 3, 4, 5 or 6 or any integer >6. In case of m=2, each of the ligands L¹ and L² may independently be

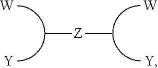

wherein in case of m=3 each of the ligands L¹ and L² may independently be

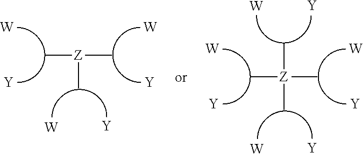

in case of m=4, and so on.

Each unit WY forms a coordination unit, i.e. one transition metal atom is coordinated to both W and Y of the same WY coordination unit. The semi-circle in the WY coordination unit represents the hydrocarbon backbone to which the metal-coordinating moiety W and Y are bonded. In neutral or charged form means that both W and Y may have, for example, the charge state 0 or -1 or any other charge state which contributes to a stable molecule.

The hydrocarbon, hetero-hydrocarbon or Si-containing backbone to which the metal-coordinating moieties W and Y are bonded may be, for example, any organic compound which is capable of linking W and Y to form the coordination unit. Generally, the hydrocarbon backbone may be an optionally substituted hydrocarbon, hetero-hydrocarbon or Si-containing backbone to which the metal-coordinating moieties W and Y are bonded. In one embodiment, the hydrocarbon backbone may be, but is not limited to, an optionally substituted C₆-C₂₀ aryl group, an optionally substituted C₆-C₂₀ heteroaryl group or an optionally substituted Si group. For example, W and Y may be linked to an aromatic hydrocarbon (aryl), to a Si-chain or the like.

In illustrative embodiments of the present invention the WY coordination unit may be, but is not limited to,

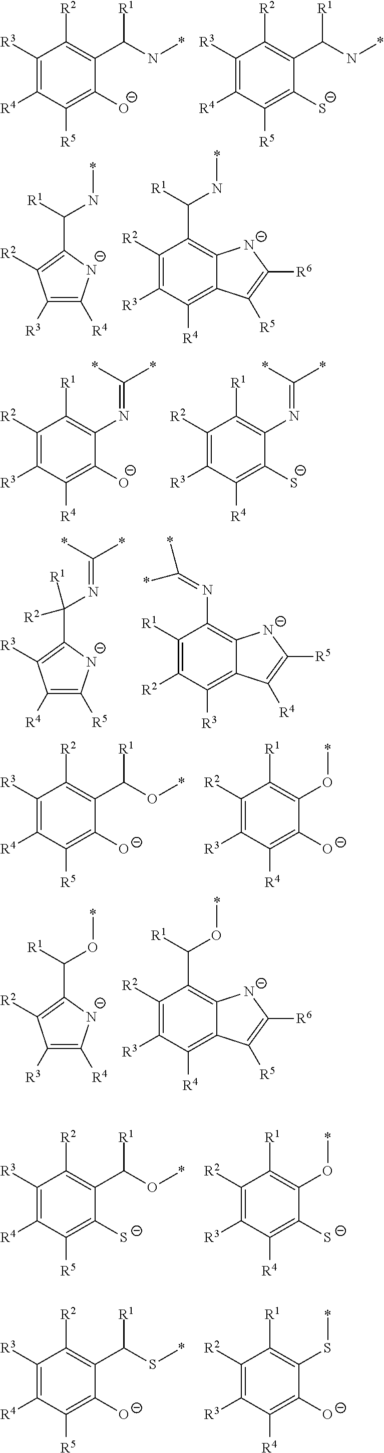

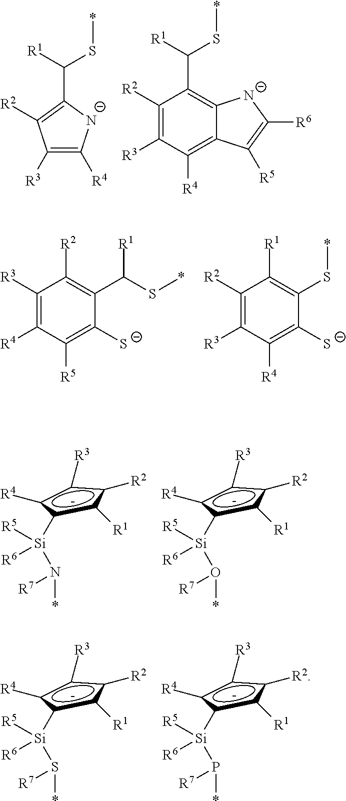

In the above formulae, the star indicates the bond/attachment to Z.

Also encompassed by the present invention are groups of the above formulae, wherein the coordinating atom is not negatively charged but substituted by a hydrogen atom. Coordination may then occur via the free electron pair of the heteroatom, for example.

In the above formula (II), Z is a spacer molecule, wherein the term “spacer molecule” refers to an atom or group of atoms that separate two or more groups from one another by a desired number of atoms. Any group of atoms may be used to separate those groups by the desired number of atoms. In some embodiments, spacers are optionally substituted. The spacer Z has a size, length and angle so that the at least two coordination sites WY of each of the ligands L¹ and L² can only bind to two different transition metal atoms and not to the same transition metal atom. In other words, this means that it is not possible that every coordination site of the same ligand L¹, for example, may bind to one and the same transition metal atom as described in the prior art. This may require that Z is structurally constrained such that the WY units are spatially arranged such that they cannot bind to the same metal atom/ion.

In this respect, the term “hydrocarbons having about 2 to about 100 carbon atoms” refer to all possible sorts of organic compounds consisting of hydrogen and carbon, e.g. aromatic hydrocarbons (aryl), alkanes, alkenes and alkyne-based compounds, but not limited to. In one embodiment of the present invention, Z may be, but is not limited to, an optionally substituted C₃-C₁₀ alicyclic group, an optionally substituted C₆-C₂₀ aryl group, an optionally substituted C₆-C₂₀ heteroaryl group, a system of condensed nucleus of fused two, three, four or five membered rings (which can optionally have heteroatoms in the ring system, such as naphthalene derivatives, anthracene derivates, quinoline, isoquinoline, quinazoline, acridinine, phenanthrene, naphthacene, chrysene, pyrene, or triphenylene, to name only a few illustrative examples), or a system of two, three or four C₆-C₂₀ aryl groups being connected via a N-atom, a Si-atom, an C₁-C₂₀ alkyl group, an C₂-C₂₀ alkenyl group or an C₆-C₂₀ aryl group. For example, the above terms may encompass compounds such as biphenyl, terphenyl or [(R¹¹R¹²R¹³R¹⁴)C₆—(CH₂)ₖ—C₆(R¹⁵R¹⁶R¹⁷R¹⁸)], wherein k is an integer from 1 to 10, and the like. All these compounds may be optionally substituted.

The term hetero-hydrocarbons having about 2 to about 100 carbon atoms refer to all sort of organic compounds consisting of hydrogen, carbon and at least one heteroatom selected from for example N, S, O, Si or P, but not limited to. For example, this term may encompass compounds according to the formula [(R¹¹R¹²R¹³R¹⁴)C₆(V)_{d}C₆(R¹⁵R¹⁶R¹⁷R¹⁸)], wherein V is Si or S and d is an integer from about 1 to about 6. All these compounds may be optionally substituted.

In case of m=2 in formula (II), examples of the spacer Z include, but are not limited to, the following benzyl, pyridyl, napthtyl, biphenyl, terphenyl, anthacenyl, phenanthrenyl, or benzyl groups being connected via a N-atom, a Si-atom, or an C₁-C₂₀ alkyl group, an C₂-C₂₀ alkenyl group or an C₆-C₂₀ aryl group,

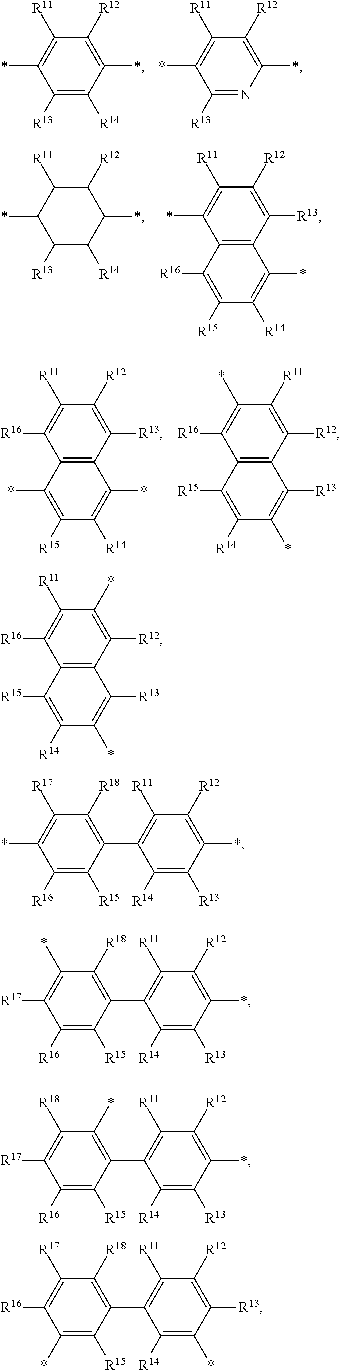

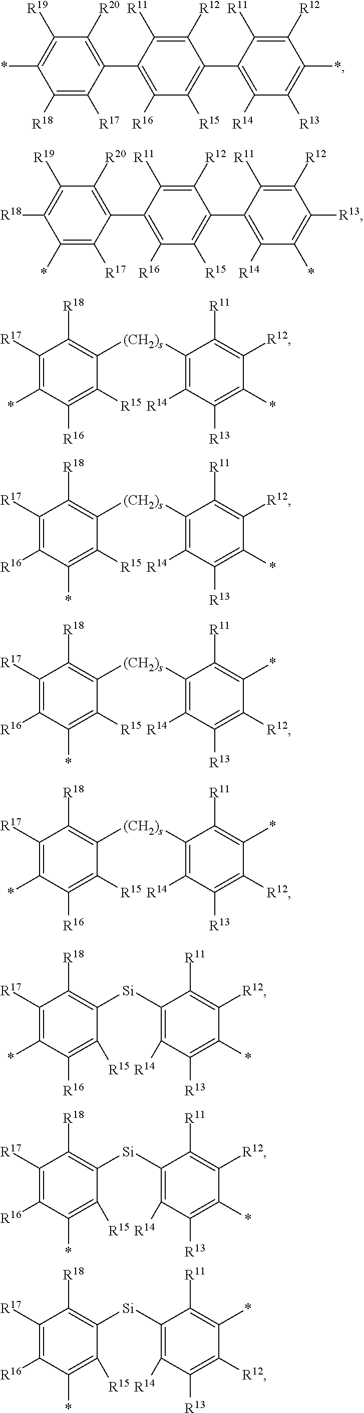

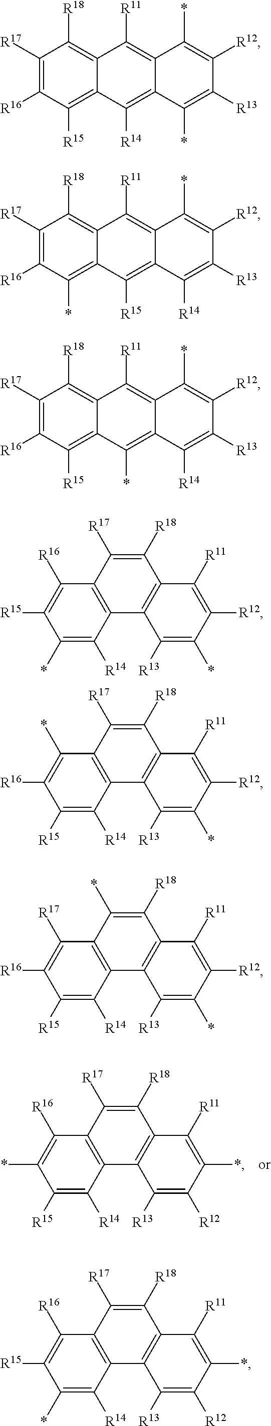

and the like. In some embodiments, s is an integer from 1 to 20, for example from 1 to about 10. In one embodiment, s may be selected from 1, 2, 3, 4, 5 or 6. In these formulae, the star indicates the point of attachment to the WY unit.

In case of m=3 in formula (II), Z is a tri-linker. This means that three of the WY coordination units may be bonded to the same spacer. Examples of the such spacer Z may be, but are not limited to,

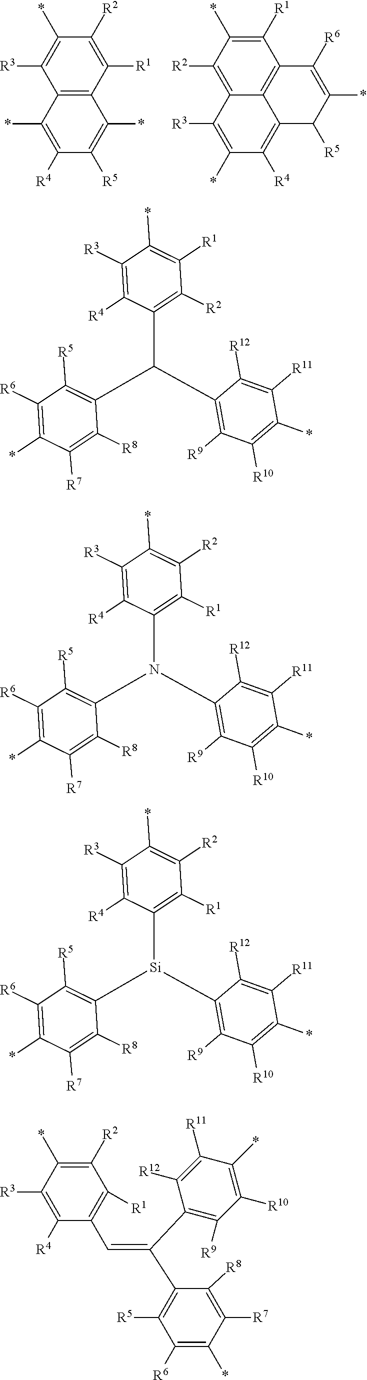

and the like. Again, the star indicates the point of attachment to each WY unit.

In case of m=4 in formula (II), Z is a tetrakis-linker. This means that four of the WY coordination units may be bonded to the same spacer. Examples of such spacer Z may be, but are not limited to,

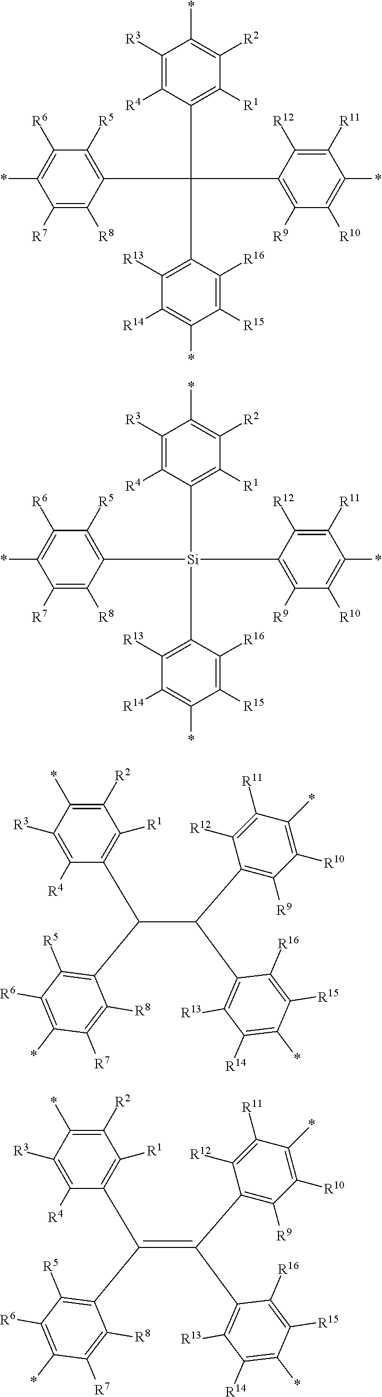

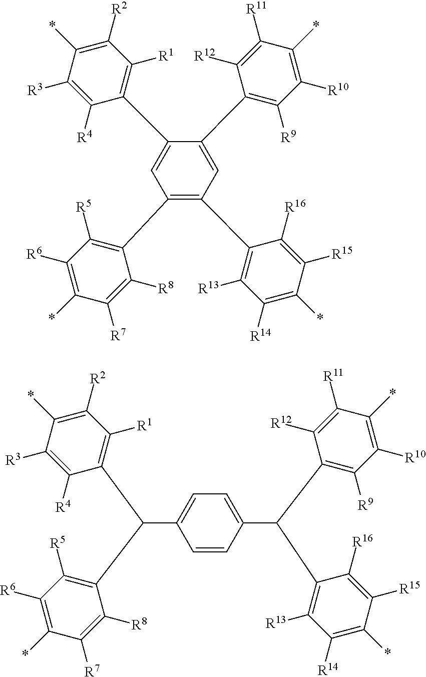

and the like. The star indicates the attachment to the WY unit.

Besides the above examples, Z may also be a multi-linker having five or more than five linking sites, i.e. m in formula (II) may be 5 or 6 or even more. In addition, Z may also be a polymeric backbone having a plurality of linking sites forming a macro polymeric multi-linker. The polymeric backbone may be, for example, polyethylene, polypropylene, and the like.

R and R¹ to R²⁰ in the above or below formulas may be the same or different and are each selected from the group consisting of H, optionally substituted straight-chain or branched C₁-C₂₀ alkyl, optionally substituted straight-chain or branched C₂-C₂₀ alkenyl, optionally substituted straight-chain or branched C₂-C₂₀ alkynyl, optionally substituted C₆-C₂₀ aryl, optionally substituted C₆-C₂₀ heteroaryl, halogen, OH, NO₂, and CN, wherein two or more of R¹ to R²⁰ may be bonded to each other to form a ring.

The term “optionally substituted straight-chain or branched C₁-C₂₀ alkyl” represented by R¹ to R²⁰ refers to a fully saturated aliphatic hydrocarbon. Whenever it appears here, a numerical range, such as 1 to 20 or C₁-C₂₀ refers to each integer in the given range, e.g. it means that an alkyl group comprises only 1 carbon atom, 2 carbon atoms, 3 carbon atoms etc. up to and including 20 carbon atoms. Examples of alky groups may be, but are not limited to, methyl, ethyl, n-propyl, isopropyl, n-butyl, isobutyl, s-butyl, t-butyl, tert.-amyl. pentyl, n-hexyl, n-heptyl, n-octyl, n-nonyl or n-decyl and the like.

The term “optionally substituted straight-chain or branched C₂-C₂₀ alkenyl” refers to an aliphatic hydrocarbon having one or more carbon-carbon double bonds. Examples of alkenyl groups may be, but are not limited to, ethenyl, propenyl, allyl or 1,4-butadienyl and the like.

The term “optionally substituted straight-chain or branched C₂-C₂₀ alkynyl” refers to an aliphatic hydrocarbon having one or more carbon-carbon triple bonds. Examples of alkynyl groups may be, but are not limited to, ethynyl, propynyl, butynyl, and the like.

The term “optionally substituted C₁-C₂₀ alkoxy” refers to a group of formula —OR, wherein R is a C₁-C₂₀ alkyl group. Examples of alkoxy groups may be, but are not limited to, methoxy, ethoxy, propoxy, and the like.

The term “optionally substituted C₃-C₁₀ alicyclic group” refers to a group comprising a non-aromatic ring, wherein each of the atoms forming the ring is a carbon atom. Such rings may be formed by 3 to 10 carbon atoms. Examples of alicyclic groups may be, but are not limited to, cyclopropane, cyclobutane, cyclopentane, cyclopentene, cyclopentadiene, cyclohexane, cyclohexene, cycloheptane, cycloheptene and the like.

The term “optionally substituted C₆-C₂₀ aryl” refers to an aromatic ring, wherein each of the atoms forming the ring is a carbon atom. Aromatic in this context means a group comprising a covalently closed planar ring having a delocalized π-electron system comprising 4b+2 π-electrons, wherein bis an integer of at least 1, for example 1, 2, 3 or 4. Examples of aryl groups may be, but are not limited to, phenyl, napthalenyl, phenanthrenyl, anthracenyl, tetralinyl, fluorenyl, indenyl, and indanyl, and the like.

The term “optionally substituted C₆-C₂₀ heteroaryl” refers to an aromatic heterocycle. Heteroaryls may comprise at least one or more oxygen atoms or at least one or more sulphur atoms or one to four nitrogen atoms or a combination thereof. Examples of heteroaryl groups may be, but are not limited to, furan, benzofuran, thiophene, benzothiophene, pyrrole, pyridine, indole, oxazole, benzoxazole, isoxazole, benzisoxazole, thiazole, benzothiazole, imidazole, benzimidazole, pyrazole, indazole, tetrazole, quinoline, isoquinoline, pyridazine, purine, pyrazine, furazan, triazole, benzotriazole, pteridine, phenoxazole, oxadiazole, benzopyrazole, quinolizine, cinnoline, phthalazine, quinazoline or quinoxaline, and the like.

The term “halogen” refers to fluorine, chlorine, bromine or iodine.

The term “optionally substituted Si group” refers to a group containing 1 to 5 silicon atoms which are substituted by hydrogen or an alkyl group or an aryl group. Examples of a Si group may be, but are not limited to, monosilane, methylsilyl, dimethylsilyl, ethylsilyl, diethylsilyl, phenylsilyl, methylphenylsilyl, and the like.

The term “a system of condensed nucleus” refers to compounds having at least two aromatic or non-aromatic condensed ring systems. Examples of condensed nucleus may be, but are not limited to, decalin, hydrindane, napthalene, anthracene, phenanthrene, naphthacene, pentacene, hexacene, pyrene, indene, fluorene, and the like.

The term “a system of two, three or four optionally substituted C₆-C₂₀ aryl groups being connected via a N-atom, a Si-atom, an C₁-C₂₀ alkyl group, an C₂-C₂₀ alkenyl group or an C₆-C₂₀ aryl group” refers to compounds having a N-atom, a Si-atom, an alkyl group, an alkenyl group or an aryl group as a central bonding unit to which two, three or four aryl groups are bonded.

Unless otherwise indicated, the term “optionally substituted,” refers to a group in which none, one, or more than one of the hydrogen atoms has been replaced with one or more group(s) independently selected from the group consisting of alkyl, aryl, heteroaryl, hydroxy, alkoxy, halogen, carbonyl, C-amido, N-amido, isocyanato, thiocyanato, isothiocyanato, nitro, silyl, and amino, including mono- and di-substituted amino groups, and the protected derivatives of amino groups. In embodiments in which two or more hydrogen atoms have been substituted, the substituent groups may be linked to form a ring.

The term “linked to form a ring” refers to the circumstance where two atoms that are bound either to a single atom or to atoms that are themselves ultimately bound, are each bound to a linking group, such that the resulting structure forms a ring. The resulting ring comprises the two atoms, the atom (or atoms) that previously linked those atoms, and the linker.

In some embodiments of the present invention, L¹ and L² are different and each ligand L¹ and L² may be independently selected from one of the following compounds, but are not limited to,

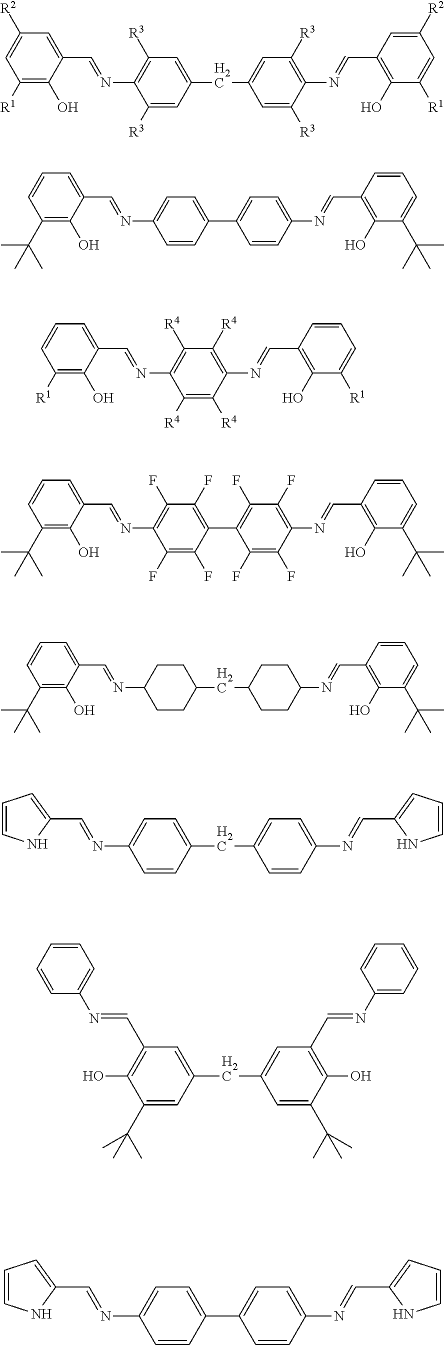

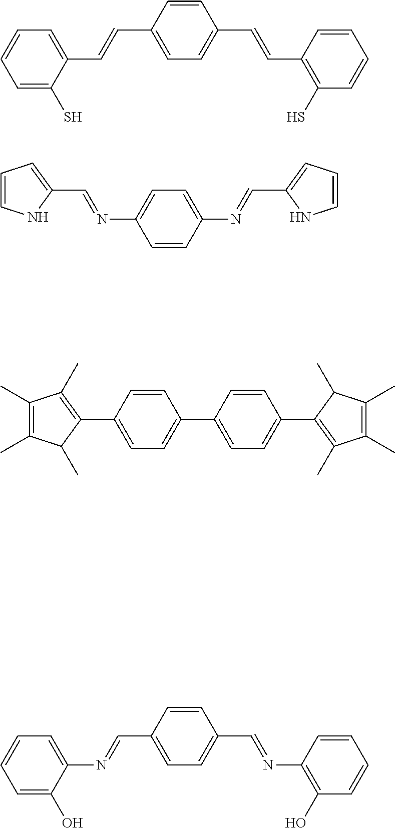

and the like, wherein R¹ to R⁴ are as described above. In further embodiments of the present invention, R¹, R², R³ and R⁴ may be the same or different, wherein R¹ is selected from the group consisting of H, CH₃ and tert-butyl; R² is selected from the group consisting of H and tert-butyl; R³ is selected from the group consisting of H, CH₃, CH₂CH₃, and CH(CH₃)₂; and R⁴ is selected from the group consisting of H, F and CH₃.

In one embodiment the ligand L¹ and L² may be

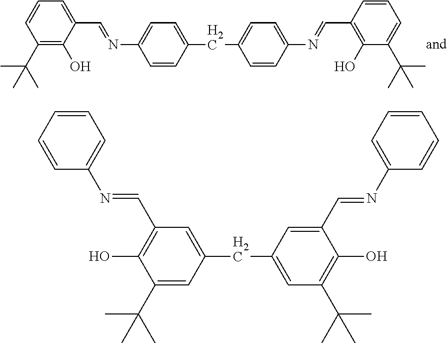

respectively.

In one embodiment, the ligand L¹ and L² may be

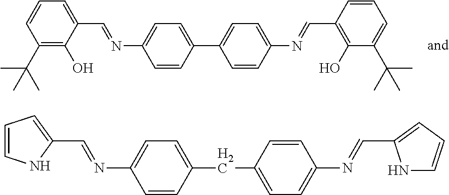

respectively.

In one embodiment the ligand L¹ and L² may be

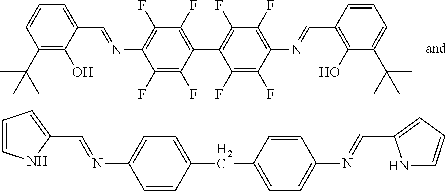

respectively.

The molar ratio of the coordination unit WY to the transition metal may be in the range of about 0.5:1 to about 6:1, for example about 1:1 to about 3:1.

In general, the ligand compounds L¹ and L² may be prepared via a Schiff-Base condensation of the respective aldehyde or ketone and the amino substituted spacer molecule. Depending on the desired geometry of the ligand, the spacer molecule may have more than one amino substituent in order to react with more than one aldehyde and/or ketone. For example, the ligand compounds may be prepared by a Schiff-Base condensation between an aldehyde or ketone with a di-aniline, tri-aniline or tetrakis-aniline. For example, the aldehyde or ketone may include, but is not limited to,

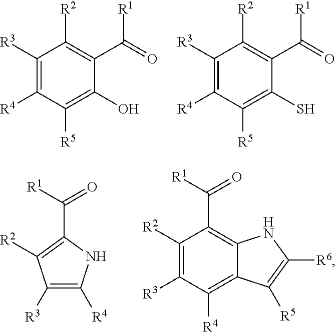

and the like, wherein R¹ to R⁶ are as described above. The di-aniline, tri-aniline or tetrakis-aniline may include, but is not limited to,

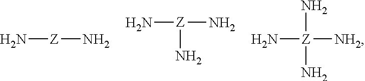

and the like wherein Z is as described above.

In an alternative embodiment, the ligand compounds L¹ and L² may also be prepared by a Schiff-Base condensation between an aniline and a di-aldehyde/di-ketone, tri-aldehyde/tri-ketone or tetrakis-aldehyde/tetrakis-ketone. The aniline may include, but is not limited to,

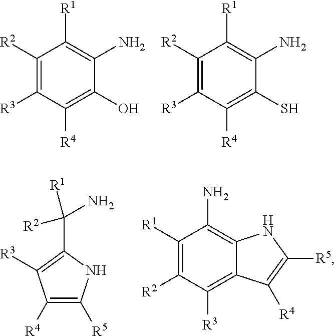

wherein R¹ to R⁵ are as described above. The di-aldehyde/di-ketone, tri-aldehyde/tri-ketone or tetrakis-aldehyde/tetrakis-ketone may include, but is not limited to,

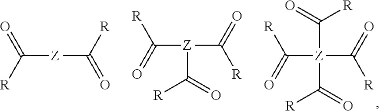

and the like wherein R and Z are as described above.

It will be understood that any other combination of aldehydes or ketones with the respective aniline compounds will be possible in the present invention to prepare the ligand compounds described above.

In the above described process for preparing the ligand compounds L¹ and L² the Schiff-Base condensation may be promoted by an acid catalyst or a solid catalyst. The acid catalyst may include, but is not limited to, formic acid, acetic acid, p-toluenesulfonic acid or a Lewis acid and the like.

Following reaction with an organolithium compound or sodium hydride (NaH), the formed ligand compound, for example, L¹ may be reacted with the respective metal compound, followed by addition of a second ligand compound, for example, L² to form the catalyst of the present invention. In some embodiments, such as that shown in Example 8, both L¹ and L² may be mixed together prior to addition of the metal compound to form the catalyst of the present invention. The self-assembly process to form the catalyst may be carried out at any temperature, such as about −100° C. to about 50° C., about −75° C. or about 25° C.

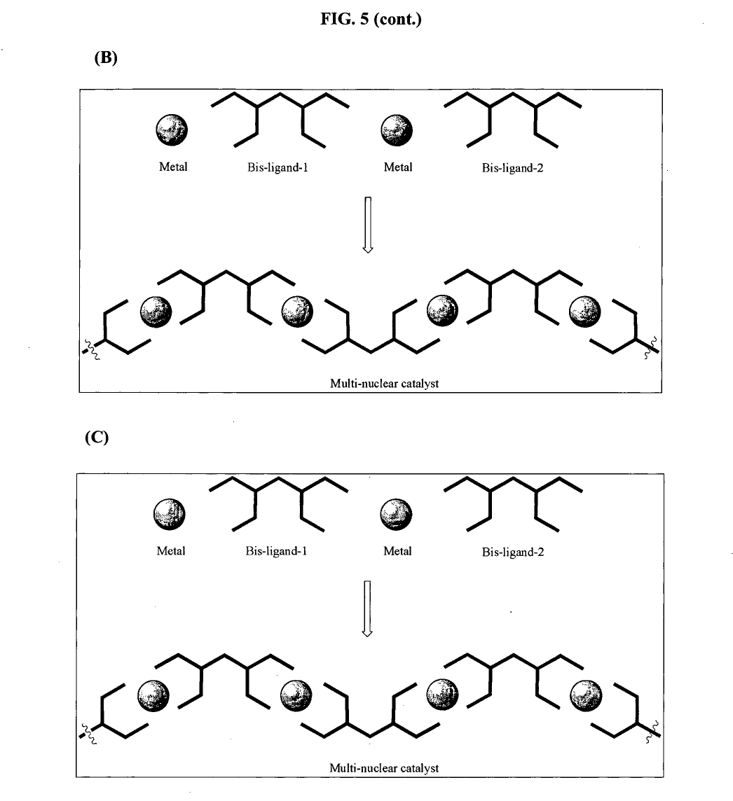

The strategy of the present invention is that the specific coordination geometry of the ligands L¹ and L² does not allow the at least two WY coordination units of each of L¹ and L² to coordinate with one and the same transition metal atom to form a mono-nuclear complex because of the spacer's size, length and angle, hence the at least two WY units of each ligand have to coordinate with two or more different transition metal atoms, thus forming self-assembled multi-nuclear catalysts. This concept can be exemplarily taken from FIG. 5, which shows each coordination site of the linked bis-ligands coordinates to one metal atom such that self-assembling starts to achieve long-lived highly efficient polymerization catalyst. Depending on the way in which the bis-ligands self-assemble, different bis-ligand combinations can be obtained, which can form a wide range of multinuclear catalysts.

The self-assembling structure may be linear, i.e. the ligands L¹ and L² may form a long chain of bis-ligand combinations with the transition metal atoms. The self-assembling structure may also be macrocyclic i.e. the long chain of bis-ligand combinations formed may be linked to form a ring. The kind of structure of the self-assembled catalyst will depend on the geometry of the used spacer Z and the kind and number of the substituents of the ligands L¹ and L². Depending on the number of the linking sites on the spacer Z, the self-assembled catalyst of the present invention may form, for example, a 3-dimensional framework.

Referring to formula (I), when g=h=p=q=r=t=u=v=0, w=y=z=1, and A=A′=B=nothing, the catalyst may have the formula (III)

L²MXₙL¹MXₙ (III).

In some embodiments, the self-assembled olefin polymerization catalyst may comprise the unit

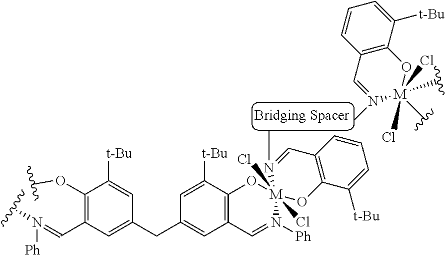

wherein the bridging spacer is

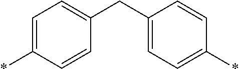 [SMILES: *c1ccc(Cc2ccc(*)cc2)cc1]

and M is Ti or Zr. In this structure “Ph” means phenyl and “t-Bu” means tert-butyl. In a catalyst of the invention the number of units may be 1 to 1000.

In some embodiments, the self-assembled olefin polymerization catalyst may comprise the unit

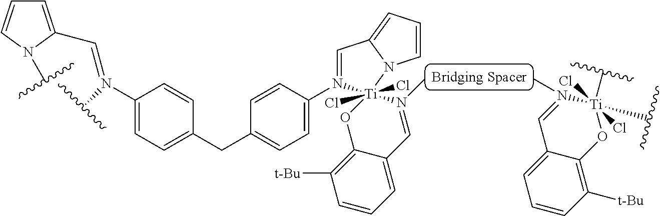

wherein the bridging spacer is

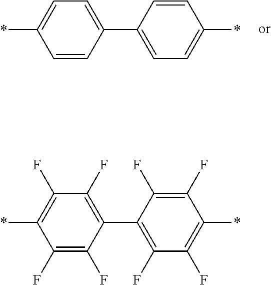 [SMILES: *c1ccc(-c2ccc(*)cc2)cc1 ; "or" ; *c1c(F)c(F)c(-c2c(F)c(F)c(*)c(F)c2F)c(F)c1F]

and M is Ti. In a catalyst of the invention the number of units may be 1 to 1000.

The self-assembled olefin polymerization catalyst of the present invention may be used together with at least one co-catalyst. In this case a catalytic system for olefin polymerization or copolymerization is formed, which may be used as such or which may be used in connection with other catalyst compounds or components necessary in the polymerization process. The at least one co-catalyst of the present invention may be, but is not limited to, an organometallic compound, an organoaluminum oxy-compound, or an ionizing ionic compound, and the like.

In one embodiment, the co-catalyst may be selected from organometallic compounds, wherein the organometallic compound may be, but is not limited to, an organometallic compound of metals of Group 1, Group 2, Group 12 and Group 13 of the Periodic Table. For example, in case of Al compounds, the compounds may be represented by the general Formula:

R^{a}ₑAl(OR^{b})_{f}HᵢXⱼ

wherein R^{a} and R^{b}, which may be the same or different, may be a hydrocarbon group of 1 to 15, for example 1 to 4 carbon atoms; X may be a halogen atom; and e, f, i and j are integers satisfying the conditions of 0<e≦3, 0≦f<3, 0<3, 0≦j<3 and e+f+i+j=3.

Examples of the above organoaluminum compound may include the following compounds, but are not limited to, organoaluminum compounds represented by the general formula

R^{a}ₑAl(OR)_{3-f},

wherein R^{a} and R^{b}, which may be the same or different, may be a hydrocarbon group of 1 to 15, for example 1 to 4 carbon atoms; and e may be a number satisfying the condition of 1.5≦e≦3.

Further exemplary compounds are represented by the general formula

R^{a}ₑAlX₃₋ₑ

wherein R^{a} is a hydrocarbon group of 1 to 15, for example 1 to 4 carbon atoms; X is a halogen atom; and e may be an integer satisfying the condition of 0<e<3.

Further exemplary compounds are represented by the general formula

R^{a}ₑAlH₃₋ₑ

wherein R^{a} is a hydrocarbon group of 1 to 15, for example 1 to 4 carbon atoms; and e may be an integer satisfying the condition of 2≦e<3.

Further exemplary compounds are represented by the general formula

R^{a}ₑAl(OR^{b})_{f}Xⱼ

wherein R^{a} and R^{b}, which may be the same or different, may be a hydrocarbon group of 1 to 15, for example 1 to 4 carbon atoms; X may be a halogen atom; and e, f and j are integers satisfying the conditions of 0<e≦3, 0<f≦3, 0≦j<3 and e+f+j=3.

Specific examples of the above organoaluminum compounds may include, but are not limited to, tri-n-alkylaluminums, such as trimethylaluminum, triethylaluminum, tri-n-butylaluminum, tripropylaluminum, tripentylaluminum, trihexylaluminum, trioctylaluminum and tridecylaluminum; branched-chain trialkylaluminums, such as triisopropylaluminum, triisobutylaluminum, tri-sec-butylaluminum, tri-t-butylaluminum, tri-2-methylbutylaluminum, tri-3-methylbutylaluminum, tri-2-methylpentylaluminum, tri-3-methylpentylaluminum, tri-4-methylpentylaluminum, tri-2-methylhexylaluminum, tri-3-methylhexylaluminum and tri-2-ethylhexylaluminum; tricycloalkylaluminums, such as tricyclohexylaluminum and tricyclooctylaluminum; triarylaluminums, such as triphenylaluminum and tritolylaluminum; dialkylaluminum hydrides, such as diisobutylaluminum hydride; trialkenylaluminums represented by the formula (i-C₄H₉)ₓAl_{y}(C₅H₁₀)_{z} (wherein x, y and z are positive numbers, and z≧2×), such as triisoprenylaluminum; alkylaluminum alkoxides, such as isobutylaluminum methoxide, isobutylaluminum ethoxide and isobutylaluminum isopropoxide; dialkylaluminum alkoxides, such as dimethylaluminum methoxide, diethylaluminum ethoxide and dibutylaluminum butoxide; alkylaluminum sesquialkoxides, such as ethylaluminum sesquiethoxide and butylaluminum sesquibutoxide; partially alkoxylated alkylaluminums having an average composition, represented by R^{a}_{2.5}Al(OR^{b})_{0.5}; dialkylaluminum aryloxides, such as diethylaluminum phenoxide, diethylaluminum(2,6-di-t-butyl-4-methylphenoxide), ethylaluminum bis-(2,6-di-t-butyl-4-methylphenoxide), diisobutylalumium(2,6-di-t-butyl-4-methylphenoxide) and isobutylaluminum bis(2,6-di-t-butyl-4-methylphenoxide); dialkylaluminum halides, such as dimethylaluminum chloride, diethylaluminum chloride, dibutylaluminum chloride, diethylaluminum bromide and diisobutylaluminum chloride; alkylaluminum sesquihalides, such as ethylaluminum sesquichloride, butylaluminum sesquichloride and ethylaluminum sesquibromide, partially halogenated alkylaluminums, such as alkylaluminum dihalides, e.g., ethylaluminum dichloride, propylaluminum dichloride and butylaluminum dibromide; dialkylaluminum hydrides, such as diethylaluminum hydride and dibutylaluminum hydride; partially hydrogenated alkylaluminums, such as alkylaluminum dihydrides, e.g., ethylaluminum dihydride and propylaluminum dihydride; and partially alkoxylated and halogenated alkylaluminums, such as ethylaluminum ethoxychloride, butylaluminum butoxychloride and ethylaluminum ethoxybromide.

Also employable are compounds analogous to the above organoaluminum compounds. For example, there can be mentioned organoaluminum compounds wherein two or more aluminum compounds are combined through a nitrogen atom, such as (C₂H₅)₂AlN(C₂H₅)Al(C₂H₅)₂.

In one embodiment, the above organometallic compound may be a compound of a Group 1 metal of the Periodic Table and aluminum represented by the general formula

M²AlR^{a}₄

wherein M² is Li, Na or K; and R^{a} is a hydrocarbon group of 1 to 15, for example 1 to 4 carbon atoms. Examples of these organoaluminum compounds include, but are not limited to, LiAl(C₂H₅)₄ and LiAl(C₇H₁₅)₄, and the like.

In a further embodiment, the above organometallic compound may be a compound of a Group 2 Metal or a Group 12 Metal of the Periodic Table represented by the general formula

R^{a}R^{b}M³

wherein R^{a} and R^{b}, which may be the same or different, may be a hydrocarbon group of 1 to 15, preferably 1 to 4 carbon atoms; and M³ is Mg, Zn or Cd.

Further, other compounds such as methyllithium, ethyllithium, propyllithium, butyllithium, methylmagnesium bromide, methylmagnesium chloride, ethylmagnesium bromide, ethylmagnesium chloride, propylmagnesium bromide, propylmagnesium chloride, butylmagnesium bromide, butylmagnesium chloride, dimethylmagnesium, diethylmagnesium, dibutylmagnesium and butylethylmagnesium may also be employable as the above organometallic compound. Furthermore, combinations of compounds capable of forming the aforesaid organoaluminum compounds in the polymerization system, e.g., a combination of halogenated aluminum and alkyllithium and a combination of halogenated aluminum and alkylmagnesium, are also employable. The above organometallic compounds may be used singly or in combination.

The organoaluminum oxy-compound may be conventional aluminoxane or a benzene-insoluble organoaluminum oxy-compound as exemplified in JP-A-2 (1990)/78687. The conventional aluminoxane can be prepared by, for example, the following processes, and is usually obtained as a hydrocarbon solvent solution:

(1) A process wherein such an organoaluminum compound as trialkylaluminum is added to a hydrocarbon medium suspension of a compound containing absorbed water or a salt containing water of crystallization, such as magnesium chloride hydrate, copper sulfate hydrate, aluminum sulfate hydrate, nickel sulfate hydrate or cerous chloride hydrate, to react the absorbed water or the water of crystallization with the organoaluminum compound.
(2) A process wherein water, ice or water vapor is allowed to act directly on such an organoaluminum compound as trialkylaluminum in a medium, such as benzene, toluene, ethyl ether or tetrahydrofuran.
(3) A process wherein an organotin oxide, such as dimethyltin-oxide or dibutyltin oxide, is allowed to react with such an organoaluminum compound as trialkylaluminum in a medium, such as decane, benzene or toluene.

The aluminoxane may contain a small amount of an organometallic component. The solvent or the unreacted organoaluminum compound is distilled off from the recovered solution of aluminoxane and the remainder may be redissolved in a solvent or suspended in a poor solvent of aluminoxane. Examples of the organoaluminum compound used for preparing the aluminoxane include the same organoaluminum compounds as described above. The organo aluminum compounds can be used singly or in combination.

Examples of the solvent used in preparing the aluminoxane include aromatic hydrocarbons, such as benzene, toluene, xylene, cumene and cymene; aliphatic hydrocarbons, such as pentane, hexane, heptane, octane, decane, dodecane, hexadecane and octadecane; alicyclic hydrocarbons, such as cyclopentane, cyclohexane, cyclooctane and methylcyclopentane; petroleum fractions, such as gasoline, kerosine and gas oil; and halides of these aromatic, aliphatic and alicyclic hydrocarbons, particularly chlorides and bromides thereof. Also employable are ethers such as ethyl ether and tetrahydrofuran. Of the solvents, particularly preferable are aromatic hydrocarbons and aliphatic hydrocarbons.

The benzene-insoluble organoaluminum oxy-compound used in the invention preferably has a content of Al component which is soluble in benzene at about 60° C. of usually not more than about 10%, for example not more than about 5%, such as not more than about 2%, in terms of Al atom. That is, the benzene-insoluble organoaluminum oxy-compound is preferably insoluble or hardly soluble in benzene.

The organoaluminum oxy-compound employable in the invention is, for example, an organoaluminum oxy-compound containing boron, which is represented by the following formula (XX)

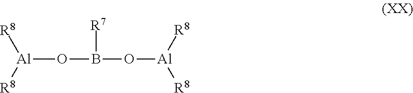

wherein R⁷ is a hydrocarbon group of 1 to 10 carbon atoms; and the groups R⁸, which may be the same or different, may be a hydrogen atom, a halogen atom or a hydrocarbon group of 1 to 10 carbon atoms.

The organoaluminum oxy-compound containing boron that is represented by the formula (XX) can be prepared by reacting an alkylboronic acid represented by the following formula (XXI) with an organoaluminum compound in an inert solvent under an inert gas atmosphere at a temperature of about −80° C. to room temperature for about 1 minute to about 24 hours:

R⁷—B—(OH)₂ (XXI)

wherein R⁷ is the same as mentioned above. Examples of the alkylboronic acid represented by the formula (XXI) include methylboronic acid, ethylboronic acid, isopropylboronic acid, n-propylboronic acid, n-butylboronic acid, isobutylboronic acid, n-hexylboronic acid, cyclohexylboronic acid, phenylboronic acid, 3,5-difluoroboronic acid, pentafluorophenylboronic acid and 3,5-bis(trifluoromethyl)phenylboronic acid. Of these, preferable are methylboronic acid, n-butylboronic acid, isobutylboronic acid, 3,5-difluorophenylboronic acid and pentafluorophenylboronic acid. These alkylboronic acids are used singly or in combination. Examples of the organoaluminum compound to be reacted with the alkylboronic acid include the same organoaluminum compounds as described for the organoaluminum compounds above. These organoaluminum compounds can be used singly or in combination.

In one embodiment the co-catalyst may be selected from organoaluminium compounds, wherein the organo aluminium compound may be, but is not limited to, trialkylaluminum such as trimethylaluminum, triethylaluminum, triisobutylaluminum, trihexylaluminum, trio ctylaluminum, and tridecylaluminum; alkylaluminum halides such as diethylaluminum monochloride, diisobutylaluminum monochloride, ethylaluminum sesquichloride, and ethylaluminum dichloride; alkylaluminum hydrides such as diethylaluminum hydride, and diisobutylaluminum hydride. In one embodiment of the present invention the co-catalyst may be a methyl aluminoxane (MAO) and/or a modified methyl aluminoxane (MMAO).

The organoaluminum oxy-compounds mentioned above are used singly or in combination.

The compound that reacts with the transition metal compound to form an ion pair (also referred to as ionizing ionic compound may include, but is not limited to, Lewis acids, ionic compounds, borane compounds and carborane compounds as described in JP-A-1 (1989)/501950, JP-A-1(1989)/502036, JP-A-3 (1991)/179005, JP-A-3 (1991)/179006, JP-A-3 (1991)/207703 and JP-A-3 (1991)/207704, and U.S. Pat. No. 5,321,106. Examples further include heteropoly compounds and isopoly compounds.

Examples of the Lewis acids include compounds represented by BR₃ (wherein R is a phenyl group which may have a substituent group such as fluorine, methyl or trifluoromethyl, or a fluorine atom), such as, but are not limited to, trifluoroboron, triphenylboron, tris(4-fluorophenyl)boron, tris(3,5-difluorophenyl)boron, tris(4-fluoromethylphenyl)boron, tris(pentafluorophenyl)boron, tris(p-tolyl)boron, tris(o-tolyl)boron and tris(3,5-dimethylphenyl)boron.

Examples of the ionic compounds include compounds represented by the following formula (XXII)

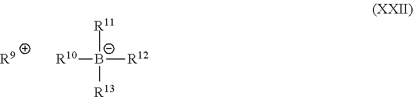

In the above formula, R⁹ may be H⁺, carbonium cation, oxonium cation, ammonium cation, phosphonium cation, cycloheptyltrienyl cation, ferrocenium cation having a transition metal, or the like. R¹⁰ to R¹³, which may be the same or different, are each an organic group, preferably an aryl group or a substituted aryl group. Examples of the carbonium cation include tri-substituted carbonium cations, such as triphenylcarbonium cation, tri(methylphenyl)carbonium cation and tri(dimethylphenyl)carbonium cation. Examples of the ammonium cation include trialkylammonium cations, such as trimethylammonium cation, triethylammonium cation, tripropylammonium cation, tributylammonium cation and tri(n-butyl)ammonium cation; N,N-dialkylanilinium cations, such as N,N-dimethylanilinium cation, N,N-diethylanilinium cation and N,N-2,4,6-pentamethylanilinium cation; and dialkylammonium cations, such as di(isopropyl)ammonium cation and dicyclohexylammonium cation. Examples of the phosphonium cation include triarylphosphonium cations, such as triphenylphosphonium cation, tri(methylphenyl)phosphonium cation and tri(dimethylphenyl)phosphonium cation.

R⁹ is preferably carbonium cation or ammonium cation, particularly preferably triphenylcarbonium cation, N,N-dimethylanilinium cation or N,N-diethylanilinium cation.

Examples of the ionic compounds further include trialkyl-substituted ammonium salts, N,N-dialkylanilinium salts, dialkylammonium salts and triarylphosphonium salts. Examples of the trialkyl-substituted ammonium salts include triethylammoniumtetra(phenyl)boron, tripropylammoniumtetra(phenyl)boron, tri(n-butyl)ammoniumtetra(phenyl)boron, trimethylammoniumtetra(p-tolyl)boron, trimethylammoniumtetra(o-tolyl)boron, tri(n-butyl)ammoniumtetra(pentafluorophenyl)boron, tripropylammoniumtetra-(o,p-dimethylphenyl)boron, tri(n-butyl)ammoniumtetra(m,m-dimethylphenyl)boron, tri(n-butyl)ammoniumtetra(p-trifluoromethylphenyl)boron, tri(n-butyl)ammoniumtetra(3,5-ditrifluoromethylphenyl) boron and tri(n-butyl)ammoniumtetra(o-tolyl)boron.

Examples of the N,N-dialkylanilinium salts include N,N-dimethylaniliniumtetra(phenyl)boron, N,N-diethylaniliniumtetra(phenyl)boron and N,N-2,4,6-pent amethylaniliniumtetra(phenyl)boron.

Examples of the dialkylammonium salts include di(1-propyl)ammoniumtetra(pentafluorophenyl)boron and dicyclohexylammoniumtetra(phenyl)boron. Examples of the ionic compounds further include triphenylcarbeniumtetrakis(pentafluorophenyl)borate, N,N-dimethylaniliniumtetrakis(pentafluorophenyl)borate, ferroceniumtetra(pentafluorophenyl)borate, triphenylcarbeniumpentaphenylcyclopentadienyl complex, N,N-diethylaniliniumpentaphenylcyclopentadienyl complex and boron compounds represented by the following formula (XXIII) or (XXIV)

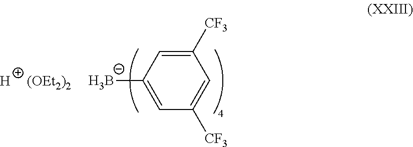

wherein Et is an ethyl group,

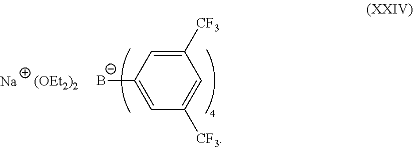

Examples of the borane compounds include, but are not limited to, decaborane; salts of anions, such as bis[tri(n-butyl)ammonium]nonaborate, bis[tri(n-butyl)ammonium]decaborate, bis[tri(n-butyl)ammonium]undecaborate, bis[tri(n-butyl)ammonium]dodecaborate, bis[tri(n-butyl)ammonium]decachloro decaborate and bis[tri(n-butyl)ammonium]dodecachlorododecaborate; and salts of metallic borane anions, such as tri(n-butyl)ammoniumbis(dodecahydridododecaborato) cobaltate(III) and bis[tri(n-but yl)ammonium]bis(dodecahydridododecaborato) nickelate(III).

Examples of the carborane compounds may include, but are not limited to, salts of anions, such as 4-carbanonaborane, 1,3-dicarbanonaborane, 6,9-dicarbadecaborane, dodecahydrido-1-phenyl-1,3-dicarbanonaborane, dodecahydrido-1-methyl-1,3-dicarbanonaborane, undecahydrido-1,3-dimethyl-1,3-dicarbanonaborane, 7,8-dicarbaundecaborane, 2,7-dicarbaundecaborane, undecahydrido-7,8-dimethyl-7,8-dicarbaundecaborane, do decahydrido-11-methyl-2,7-dicarbaundecaborane, tri(n-butyl)ammonium-1-carbadecaborate, tri(n-butyl)ammonium-1-carbaundecaborate, tri(n-butyl)ammonium-1-carbadodecaborate, tri(n-butyl)ammonium-1-trimethylsilyl-1-carbadecaborate, tri(n-butyl)ammoniumbromo-1-carbadodecaborate, tri(n-butyl)ammonium-6-carbadecaborate, tri(n-butyl)ammonium-6-carbadecaborate, tri(n-butyl)ammonium-7-carbaundecaborate, tri(n-butyl)ammonium-7,8-dicarbaundecaborate, tri(n-butyl)ammonium-2,9-dicarbaundecaborate, tri(n-butyl)ammoniumdodecahydrido-8-methyl-7,9-dicarbaundecaborate, tri(n-but yl)ammoniumundecahydrido-8-ethyl-7,9-dicarbaundecaborate, tri(n-butyl)ammoniumundecahydrido-8-butyl-7,9-dicarbaundecaborate, tri(n-butyl)ammoniumundecahydrido-8-allyl-7,9-dicarbaundecaborate, tri(n-butyl)ammoniumundecahydrido-9-trimethylsilyl-7,8-dicarbaundecaborate and tri(n-butyl)ammoniumundecahydrido-4,6-dibromo-7-carbaundecaborate; and salts of metallic carborane anions, such as tri(n-butyl)ammoniumbis(nonahydrido-1,3-dicarbanonaborato) cobaltate(III), tri(n-butyl)ammoniumbis(undecahydrido-7,8-dicarbaundecaborato)ferrate(III), tri(n-butyl)ammoniumbis(undecahydrido-7,8-dicarbaundecaborato)cobaltate(III), tri(n-butyl)ammoniumbis(undecahydrido-7,8-dicarbaundecaborato)nickelate(III), tri(n-butyl)ammoniumbis(undecahydrido-7,8-dicarbaundecaborato)cuprate(III), tri(n-butyl)ammoniumbis(undecahydrido-7,8-dicarbaundecaborato)aurate(III), tri(n-butyl)ammoniumbis(nonahydrido-7,8-dimethyl-7,8-dicarbaundecaborato)ferrate(III), tri(n-butyl)ammoniumbis(nonahydrido-7,8-dimethyl-7,8-dicarbaundecaborato)chromate(III), tri(n-butyl)ammoniumbis(tribromooctahydrido-7,8-dicarbaundecaborato)cobaltate(III), tris[tri(n-butyl)ammonium]bis(undecahydrido-7-carbaundecaborato)chromate(III), bis[tri(n-butyl)ammonium]bis(undecahydrido-7-carbaundecaborato)manganate(IV), bis[tri(n-but yl)ammonium]bis(undecahydrido-7-carbaundecaborato)cobaltate(III) and bis[tri(n-but yl)ammonium]bis(undecahydrido-7-carbaundecaborato)nickelate(IV).

The heteropoly compounds comprise an atom selected from silicon, phosphorus, titanium, germanium, arsenic and tin, and at least one atom selected from vanadium, niobium, molybdenum and tungsten. Examples of the heteropoly compounds include without limiting thereto phosphovanadic acid, germanovanadic acid, arsenovanadic acid, phosphoniobic acid, germanoniobic acid, siliconomolybdic acid, phosphomolybdic acid, titanomolybdic acid, germanomolybdic acid, arsenomolybdic acid, stannnomolybdic acid, phosphotungstic acid, germanotungstic acid, stannotungstic acid, phosphomolybdovanadic acid, phosphotungstovanadic acid, germanotungstovanadic acid, phosphomolybdotungstovanadic acid, germanomolybdotungstovanadic acid, phosphomolybdotungstic acid and phosphomolybdoniobic acid, salts of these acids with a metal of Group 1 or Group 2 of the Periodic Table, such as lithium, sodium, potassium, rubidium, cesium, beryllium, magnesium, calcium, strontium or barium, and organic salts of these acids with a triphenylethyl salt.

In one embodiment of the present invention, the co-catalyst may be a conventional methyl aluminoxane (MAO), a modified methyl aluminoxane (MMAO), a metal salt of (C₆F₅)₄B⁻ or a combination of an alkyl aluminium compound with MgCl₂.

The ionizing ionic compounds mentioned above can be used singly or in combination.

The catalyst:co-catalyst ratio may be about in the range of about 1:1 to about 1:5000, for example in the range of about 1:10 to about 1:2000.

The self-assembled olefin polymerization catalyst of the present invention may be supported by an inorganic or organic carrier material. The inorganic compound for the carrier may include, but is not limited to, inorganic oxides, inorganic chlorides, and other inorganic salts such as sulfates, carbonates, phosphates, nitrates, silicates, and the like.

In one embodiment the inorganic compounds for the carrier may be inorganic oxides such as silica, titania, alumina, zirconia, chromia, magnesia, boron oxide, calcium oxide, zinc oxide, barium oxide, silica xerogel, silica aerogel, and mixtures thereof such as silica/chromia, silica/chromia/titania, silica/alumina, silica/titania, silica/magnesia, silica/magnesia/titania, aluminum phosphate gel. The inorganic oxide may contain a carbonate salt, a nitrate salt, a sulphate salt, an oxide, including Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O, and Li₂O.

The inorganic compound used in the present invention may also include, but is not limited to, inorganic compound polymers such as carbosiloxane, phosphazyne, siloxane, and polymer/silica composites.

In one embodiment of the present invention the inorganic carrier material may be, but is not limited to, silica, alumina, titania, magnesium chloride, and mixtures thereof.

In a further embodiment of the present invention, the organic compound useful as the carrier may include, but is not limited to, polyethylene, ethylene/[α]-olefin copolymers, polypropylene, polystyrenes, functionalized polyethylenes, functionalized polypropylenes, functionalized polystyrenes, polyketones and polyesters.

Another embodiment of the present invention is directed to a process for polymerization or copolymerization of an olefin or a mixture of olefins in the presence of the self-assembled olefin polymerization catalyst according to the invention and optionally in the presence of at least one of the above mentioned co-catalysts.

The temperature of polymerization with the olefin polymerization catalyst is in the range usually from about −50 to about +200° C., such as from about −20° C. to about 150° C. In another embodiment, the temperature is in the range of about 0° C. to about 100° C. In another embodiment, the temperature may be in the range of about 40 to about 60° C. The polymerization pressure is in the range usually from atmospheric pressure (about 0.1 MPa) to about 10 MPa. For example, the pressure may be in the range of about 0.5 to about 1.0 MPa. The polymerization may be conducted by any of a batch system, a semicontinuous system, and a continuous system or the like. The polymerization can be conducted in two or more steps under different reaction conditions.

The molecular weight of the produced olefin polymer may be controlled, for example, by presence of hydrogen in the polymerization system or the change of polymerization temperature or pressure. With the catalyst of the present invention polymers having a number molecular weight from about 3.000 to about 3.000.000 can be obtained. It is very useful that the catalysts of the present invention can produce low molecular weight polyolefins as well as ultra high molecular weight polyolefins of more than one million with narrow molecular weight distribution.

The molecular weight may depend on several factors. For example, the substituents of the catalyst system may influence the molecular weight, for example bulkier substituents (in particular adjacent to the WY coordination unit) may give higher molecular weight. Further, a higher ethylene pressure may also contribute to a higher molecular weight. Also, a higher hydrogen pressure may lead to a lower molecular weight. The kind of metal atom in the catalyst plays also a decisive role. For example, the use of titanium may give higher molecular weight than the use of zirconium. The present invention also revealed that self-assembling increased molecular weight compared to corresponding mono-nuclear catalyst. In general it may be stated without being bound to any particular theory that higher molecular weight may give a higher melting point and better mechanical properties.

The olefins which can be polymerized according to the present invention include linear or branched α-olefins of 2-30, for example 2-20 carbon atoms. In one embodiment the olefins may be, but are not limited to, ethylene, propylene, 1-butene, 2-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, and 1-icosene; cycloolefins of 3-30, for example 3-20 carbon atoms such as, for example, cyclopentene, cycloheptene, norbornene, 5-methyl-2-norbornene, and tetracyclododecene; polar monomers: including α,β-unsaturated carboxylic acid such as acrylic acid, methacrylic acid, fumaric acid, maleic anhydride, itaconic acid, itaconic anhydride, and bicyclo[2.2.1]-5-heptene-2,3-dicarboxylic acid anhydride, and α,β-unsaturated carboxylic acid metal salts such as salts thereof of sodium, potassium, lithium, zinc, magnesium, and calcium; α,β-unsaturated carboxylic acid esters such as methyl acrylate, ethyl acrylate, n-propyl acrylate, isopropyl acrylate, n-butyl acrylate, isobutyl acrylate, t-butyl acrylate, 2-ethylhexyl acrylate, methyl methacrylate, ethyl methacrylate, n-propyl methacrylate, isopropyl methacrylate, n-butyl methacrylate, and isobutyl methacrylate; vinyl esters such as vinyl acetate, vinyl propionate, vinyl caproate, vinyl caprylate, vinyl laureate, vinyl stearate, and vinyl trifluoroacetate; and unsaturated glycidyl esters such as glycidyl acrylate, glycidyl methacrylate, and monoglycidyl itaconate.

Vinylcyclohexane, dienes, and polyenes are also useful. The diene and polyenes include cyclic or linear compounds having two or more double bonds having 4-30, such as 4-20 carbon atoms, specifically including butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidenenorbornene, vinylnorbornene, dicyclopentadiene, 7-methyl-1,6-octadiene, 4-ethylidene-8-methyl-1,7-nonadiene, and 5,9-dimethyl-1,4,8-decatriene. Further useful are aromatic vinyl compounds including mono- or polyalkylstyrenes such as styrene, o-methylstyrene, m-methylstyrene, p-methylstyrene, o,p-dimethylstyrene, o-ethylstyrene, m-ethylstyrene, p-ethylstyrene; functional group-containing styrene derivatives such as methoxystyrene, ethoxystyrene, vinylbenzoic acid, methyl vinylbenzoate, vinylbenzyl acetate, hydroxystyrene, o-chlorostyrene, p-chlorostyrene, and divinylbenzene; 3-phenylpropylene, 4-phenylpropylene, and [alpha]-methylstyrene.

In one embodiment of the present invention the olefins may be, but are not limited to, C₂-C₃₀ α-olefins, C₂-C₃₀ functionalized alkenes, cycloalkenes, norborene and derivatives thereof, dienes, acetylenes, styrene, alkenols, alkenoic acids and derivatives or mixtures thereof. Thus, the olefins may be ethylene, propylene, butene, pentene, hexene, 4-methyl-1-pentene, octene, norborene or methacrylate. In one embodiment the olefin is ethylene or propylene. These α-olefins or functionalized alkenes may be used singly or in combination of two or more thereof. In some embodiments, the olefins may be ethylene, C₆ alkenes, and their derivatives or mixtures thereof. In further embodiments, the olefins may be ethylene and 1-hexene, their derivatives or mixtures thereof.

The olefin polymerization catalyst of the present invention has a high polymerization activity, giving a polymer having a narrow molecular weight distribution, and giving an olefin copolymer having narrow composition distribution in copolymerization of two or more olefins.

The olefin polymerization catalyst of the present invention may also be used for copolymerization of an α-olefin and a conjugated diene.

The conjugated diene includes aliphatic conjugated dienes of 4-30, such as 4-20 carbon atoms. Examples of such dienes may be, but are not limited to, 1,3-butadiene, isoprene, chloroprene, 1,3-cyclohexadiene, 1,3-pentadiene, 4-methyl-1,3-pentadiene, 1,3-hexadiene, and 1,3-octdiene. These conjugate dienes may be use singly or in combination of two or more thereof.

In the present invention, in copolymerization of an α-olefin and a conjugated diene, a nonconjugated diene or a polyene may be additionally used. The nonconjugated diene and the polyene include, but is not limited to, 1,4-pentadiene, 1,5-hexadiene, 1,4-hexadiene, 1,4-octadiene, 1,5-octadiene, 1,6-octadiene, 1,7-octadiene, ethylidenenorbornene, vinylnorbornene, dicyclopentadiene, 7-methyl-1,6-octadiene, 4-ethylidene-8-methyl-1,7-nonadiene, and 5,9-dimethyl-1,4,8-decatriene.

The process for producing an olefin polymer of the present invention gives the olefin polymer having a narrow molecular weight distribution at a high yield by polymerization in the presence of the above olefin polymerization catalyst.

In a third aspect, the present invention provides polyolefins obtainable according to the process of the present invention. The polyolefins obtained may have a molecular weight in the range from low molecular weight polyolefins to ultra high molecular weight polyolefins.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXAMPLES

### General Consideration of Materials and Characterization

4,4′-Diaminodiphenylmethane, benzidine, 4,4′-diaminooctafluorobiphenyl, 3-tert-butyl-2-hydroxy-benzaldehyde, pyrrole-2-carboxaldehyde and anhydrous hexane were purchased from Sigma-Aldrich and used without pre-treatment. 5,5-Methylene-di-3-tert-butyl-salicylaldehyde was prepared according to literature methods. Methyl aluminoxane solution (Al %: ˜5.2%) in toluene was purchased from Chemtura Organometallics GmbH and used directly without any pre-treatment. Methanol was dried over 4 Å molecular sieves. Dichloromethane (DCM) and tetrahydrofuran (THF) were purified using an MBRAUN-SPS solvent purification system. Experiments that involve air-sensitive materials were carried out by using standard Schlenk line techniques or in a glove box under an atmosphere of argon.

¹H-NMR and ¹³C-NMR were recorded in CDCl₃ on a BRUKER 400 spectrometer. HRMS (EI) was performed on a Thermo Finnigan MAT 95. HRMS (ESI) was performed on an Agilent LC-MS TOF. Elemental analysis was performed on a EuroEA3000 Series Elemental Analyzer. Metal content was tested with ICP.

High temperature GPC analyses of polyethylene were performed on a Polymer Labs GPC-220 with a refractive index detector. Typical operating conditions for analyzing polyethylene are: two PLgel 10 μm Mixed B columns (300*7.5 mm) and one PLgel 10 μm guard column (50*7.5 mm) at 160° C. using 1,2,4-trichlorobenzene stabilized with 0.0125 wt. % BHT as the eluent. Polymer samples were prepared at a concentration of 1 mg/mL using a Polymer Labs SP260 sample preparation system at 150° C. until dissolved (typically about 4 to 6 hours), followed by filtration where necessary.

FT-IR spectra were recorded on a Bruker Vertex 70 spectrometer. Laser Raman spectra were recorded on an InVia Reflex instrument (Renishaw) equipped with a near infrared enhanced deep-depleted thermoelectrically Peltier cooled CCD array detector (576×384 pixels) and a high grade Leica microscope. The methyl branching of the copolymers was measured with FT-IR by comparison against standard samples.

### Example 1

### Preparation of bis-phenoxy-imine ligand (BFI-1)

4,4′-Diaminodiphenylmethane (1.34 g, 6.76 mmol) was dissolved in anhydrous methanol (25 mL). After stirring for several minutes, 3-tert-butyl-2-hydroxy-benzaldehyde (2.65 g, 14.87 mmol) was added, followed by several drops of formic acid. The resulting mixture was stirred for one hour at room temperature and then refluxed for one day under argon atmosphere. After cooling to room temperature, the product was isolated by filtration, washed with methanol (12 mL) and dried in vacuo, resulting in 3.45 g of a yellow powder, yield 98%. ¹H-NMR (CDCl₃, 400 MHz, 5): 1.50 (s, 18H, —C(CH₃)₃), 4.04 (s, 2H, —CH₂—), 6.87˜7.42 (m, 14H, aromatic-H), 8.63 (s, 2H, —CH═N—), 13.96 (s, 2H, —OH). ¹³C-NMR (CDCl₃, 100 MHz, δ): 29.38, 34.93, 41.04, 118.34, 119.13, 121.37, 129.89, 130.30, 130.62, 137.67, 139.64, 146.66, 160.55, 162.90. Elemental analysis C₃₅H₃₈N₂O₂ (518.71): Calc.: C, 81.05%, H, 7.38%, N, 5.40%. Found: C, 80.89%, H, 7.41%, N, 5.46%. HRMS (EI, m/z): Calculated 518.2933; Found 518.2903 (M⁺).

### Example 2

### Preparation of bis-phenoxy-imine ligand (BFI-2)

The ligand BFI-2 was synthesized via the same procedure as ligand BFI-1 using aniline (1.01 g, 10.86 mmol) and 5,5-methylene-di-3-tert-butyl-salicylaldehyde (2.00 g, 5.43 mmol) in anhydrous methanol (80 mL). After reaction, the yellow slurry was concentrated to about 10 mL. The product was filtered, washed with methanol (2×5 mL) and dried in vacuo to obtain 2.56 g of a yellow powder (91% yield). ¹H-NMR (CDCl₃, 400 MHz, δ): 1.46 (s, 18H, —C(CH₃)₃), 3.92 (s, 2H, —CH₂—), 7.00˜7.42 (m, 14H, aromatic-H), 8.57 (s, 2H, —CH═N—), 13.79 (s, 2H, —OH). ¹³C-NMR (CDCl₃, 100 MHz, δ): 29.41, 34.93, 40.41, 118.93, 121.18, 126.68, 129.36, 130.28, 130.70, 131.32, 137.76, 148.53, 158.94, 163.38. Elemental analysis C₃₅H₃₈N₂O₂ (518.71): Calc.: C, 81.05%, H, 7.38%, N, 5.40%. Found: C, 81.09%, H, 7.46%, N, 5.47%. HRMS (ESI): Calculated for [M+H]⁺: 519.3006; Found 519.3004.

### Example 3

### Preparation of bis-phenoxy-imine ligand (BFI-3)

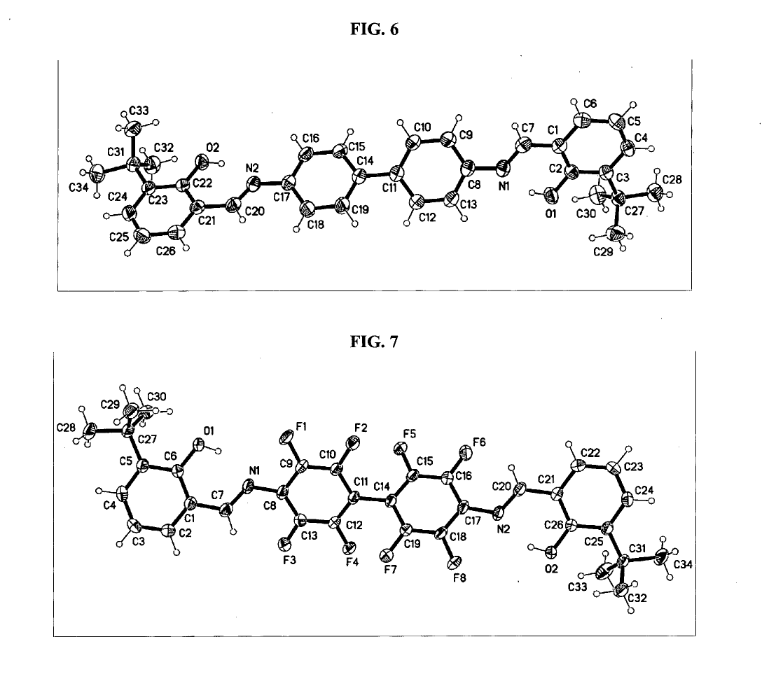

The ligand BFI-3 was synthesized via the same procedure as ligand BFI-1 using benzidine (1.06 g, 5.74 mmol) and 3-tert-butyl-2-hydroxy-benzaldehyde (2.09 g, 11.49 mmol) in anhydrous methanol (30 mL). The product was obtained as a yellow powder in 99% yield (2.80 g). ¹H-NMR (CDCl₃, 400 MHz, δ): 1.51 (s, 18H, —C(CH₃)₃), 6.90-7.71 (m, 14H, aromatic-H), 8.71 (s, 2H, —CH═N—), 13.96 (s, 2H, —OH). ¹³C-NMR (CDCl₃, 100 MHz, δ): 29.36, 34.94, 118.41, 119.12, 121.74, 127.87, 130.48, 130.71, 137.72, 138.80, 147.64, 160.61, 163.11. Elemental analysis C₃₄H₃₆N₂O₂ (504.68): Calc. C, 80.92%, H, 7.19%, N, 5.55%. Found C, 80.98%, H, 7.12%, N, 5.62%. HRMS (EI, m/z): Calculated 504.2777; Found 504.2823(M⁺). Single crystal was crystallized from toluene solution (see FIG. 6 for the crystal structure of BFI-3).

### Example 4

### Preparation of bis-phenoxy-imine ligand (BFI-4)

4,4′-diaminooctafluorobiphenyl (2.30 g, 7.0 mmol) and 3-tert-butyl-2-hydroxy-benzaldehyde (3.0 g, 16.8 mmol) were dissolved in anhydrous toluene (40 mL), followed by addition of 12 mg of para-toluenesulphonic acid. The resulting mixture was refluxed for 4 days. The solution was concentrated to about 10 mL and kept in fridge. Crystal was filtered, washed with cold toluene (2 mL) and dried in vacuo to give 2.0 g of product. Second batch product (0.76 g) was obtained by further concentrating the residual solution to about 5 mL and repeating the crystallization process. Product obtained was 2.76 g (61% yield). ¹H-NMR (CDCl₃, 400 MHz, δ): 1.49 (s, 18H, —C(CH₃)₃), 6.94˜7.53 (m, 6H, aromatic-H), 8.92 (s, 2H, —CH═N—), 12.92 (s, 2H, —OH). Elemental analysis C₃₄H₂₈F₈N₂O₂ (648.59): Calc. C, 62.96%, H, 4.35%, N, 4.32%. Found C, 63.08%, H, 4.04%, N, 4.32%. Single crystal was crystallized from toluene solution (see FIG. 7 for the crystal structure of BFI-4).

### Example 5

### Preparation of bis-pyrrolide-imine ligand (BPI-1)

4,4′-Diaminodiphenylmethane (2.61 g, 13.2 mmol) and pyrrole-2-carboxaldehyde (2.51 g, 26.4 mmol) were dissolved in anhydrous methanol (60 mL). After adding several drops of formic acid, the resulting mixture was stirred at room temperature for 2 days. The light yellow powder was filtered, washed with methanol (10 mL) and dried in vacuo to obtain 3.56 g product (77% yield). ¹H-NMR (DMSO, 400 MHz, δ): 3.92 (s, 2H, —CH₂—), 6.18˜7.00 (m, 6H, pyrrole-H), 7.11 (d, 4H, J=8.3 Hz, Phenyl-H), 7.23 (d, 4H, J=8.3 Hz, Phenyl-H), 8.29 (s, 2H, —CH═N—), 11.70 (s, broad, 2H, —OH). ¹³C-NMR (DMSO, 100 MHz, δ): 40.06, 109.65, 116.21, 120.77, 123.68, 129.41, 130.55, 138.17, 149.98.

### Example 6

### Preparation of Catalysts MNTi-3 and MNZr-3

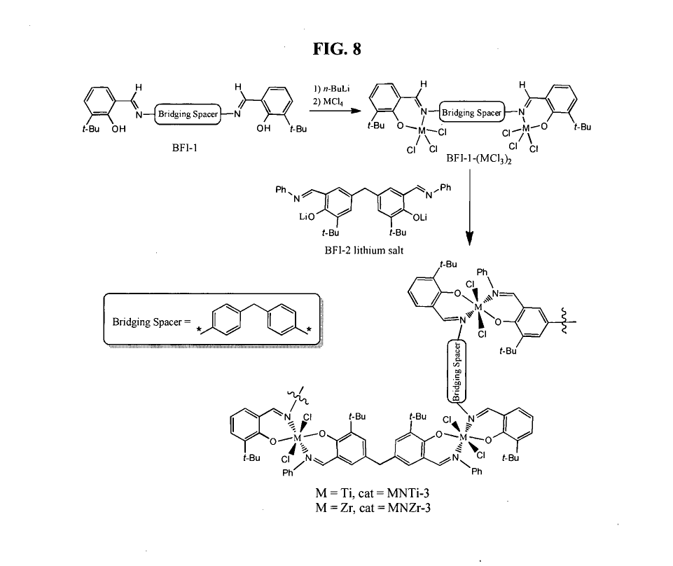

Catalysts MNTi-3 and MNZr-3 were synthesized according the reaction scheme shown in FIG. 8.

### Example 6a

### Preparation of Catalyst MNTi-3

(i) Preparation of BFI-1-(TiCl₃)₂ Solution in THF

To a stirred solution of BFI-1 (0.50 g, 0.96 mmol) in THF (15 mL), a solution of n-butyllithium (1.6M, 1.2 mL, 1.92 mmol) in hexane was added dropwise over a period of 10 minutes at −78° C. Then the mixture was allowed to warm to room temperature and stirred for two hours. The resulting solution was added dropwise to a stirred solution of TiCl₄ (0.3642 g, 1.92 mmol) in THF (15 mL) at −78° C. via a cannula over a period of 20 minutes. The resulting mixture was again warmed to room temperature and stirred for 18 hours affording a solution of BFI-1-(TiCl₃)₂ in THF.

(ii) Preparation of Catalyst MNTi-3

To a stirred solution of BFI-2 (0.50 g, 0.96 mmol) in THF (15 mL), a solution of n-butyllithium (1.6M, 1.2 mL, 1.92 mmol) in hexane was added dropwise over a period of 10 minutes at −78° C. Then the mixture was allowed to warm to room temperature and stirred for two hours. The resulting solution was added dropwise to the solution of BFI-1-(TiCl₃)₂ via a cannula over a period of 20 minutes at −78° C. The resulting mixture was warmed to room temperature and stirred for 18 hours. After removal of THF, the residue was extracted with DCM (40 mL) and filtered to give a clear solution. Removal of DCM gave a deep reddish-brown solid which is the multi-nuclear catalyst bearing a repeating unit of C₃₅H₃₆Cl₂N₂O₂Ti with residual solvent being THF and traces of DCM. The catalyst was ground to a powder and dried in vacuo at room temperature. The Ti % was found to be 6.55%. Calculated against the theoretical Ti % of 7.53% in C₃₅H₃₆Cl₂N₂O₂Ti, the residual solvent was found to be 13.01%. The catalyst yield was 1.38 g (99%). FT-IR (cm⁻¹): ν_{C═N}=1554 cm⁻¹, ν_{Ti—O}=498 cm⁻¹, ν_{Ti—Cl}=458 cm⁻¹, ν_{Ti—N}=362 cm⁻¹. Raman (cm¹): σ_{C═N}=1584 and 1541 cm⁻¹, ν_{Ti—O}=884, 866, 549 and 425 cm⁻¹, σ_{Ti—Cl}=369 cm⁻¹, σ_{Ti—N}=327 cm⁻¹.

### Example 6b

### Preparation of Catalyst MNZr-3

The title catalyst MNZr-3 was synthesized via the same procedure as MNTi-3 using BFI-1 (0.50 g, 0.96 mmol), BFI-2 (0.50 g, 0.96 mmol) and ZrCl₄ (0.4474 g, 1.92 mmol). The catalyst MNZr-3 was obtained as a pale yellow solid with a repeating unit of C₃₅H₃₆Cl₂N₂O₂Zr. The Zr % was found to be 12.09%. Calculated against the theoretical Zr % of 13.44% in C₃₅H₃₆Cl₂N₂O₂Zr, the residual solvent was found to be 10.04%. The catalyst yield was 1.41 g (97%). FT-IR (cm⁻¹): σ_{C—N}−1553 cm⁻¹, σ_{Zr—O}=445 cm¹, σ_{Zr—O}=370 cm⁻¹, σ_{Zr}—N=330 cm⁻¹.

### Example 7

### Preparation of Catalysts MNTi-4 and MNTi-5

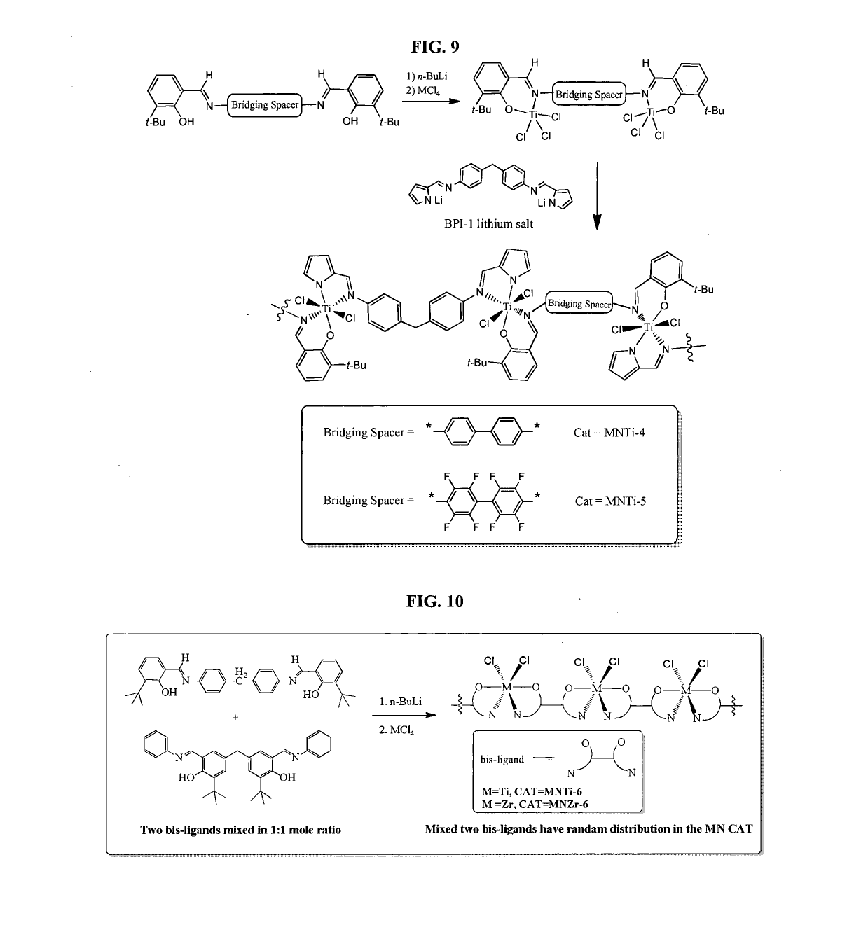

Catalysts MNTi-4 and MNZr-4 were synthesized according to the reaction scheme shown in FIG. 9.

### Example 7a

### Preparation of Catalyst MNTi-4

Catalyst MNTi-4 was synthesized via the same procedure as MNTi-3 using BFI-3 (0.50 g, 0.99 mmol), BPI-1 (349 mg, 0.99 mmol) and TiCl₄ (1.98 mmol). The catalyst MNTi-4 was obtained as a reddish-brown solid with a repeating unit of ½ (C₅₇H₅₂C₁₄N₆O₂Ti₂). The Ti % was found to be 7.62%. Calculated against the theoretical Ti % of 8.78% in ½(C₅₇H₅₂C₁₄N₆O₂Ti₂), the residual solvent was found to be 13.21%. The catalyst yield was 1.12 g (92%).

### Example 7b

### Preparation of Catalyst MNTi-5

Catalyst MNTi-5 was synthesized via the same procedure as MNTi-3 using BFI-4 (0.50 g, 0.77 mmol), BPI-1 (272 mg, 0.77 mmol) and TiCl₄ (1.54 mmol). The catalyst MNTi-5 was obtained as a reddish-brown solid with a repeating unit of ½(C₅₇H₄₄C₁₄F₈N₆O₂Ti₂). The Ti % was found to be 6.81%. Calculated against the theoretical Ti % of 7.75% in ½ (C₅₇H₄₄C₁₄F₈N₆O₂Ti₂), the residual solvent was found to be 12.12%. The catalyst yield was 1.03 g (97%).

### Example 8

### Preparation of Catalyst MNTi-6 and MNZr-6 (One Pot Mixing)

Catalysts MNTi-6 and MNZr-6 were synthesized according to the reaction scheme shown in FIG. 10.

### Example 8a

### Preparation of Catalyst MNTi-6

To a stirred solution of BFI-1 (0.5 g) and BFI-2 (0.5 g) (totally 1.00 g, 1.93 mmol) in THF (20 mL), a solution of n-butyllithium (1.6 M, 2.4 mL, 3.86 mmol) in hexane was added dropwise over a period of 10 minutes at −78° C. Then the mixture was allowed to warm to room temperature and stirred for two hours. The resulting solution was added dropwise to a stirred solution of TiCl₄ (0.3657 g, 1.93 mmol) in THF (15 mL) at −78° C. via a cannula over a period of 20 minutes. The resulting mixture was again warmed to room temperature and stirred overnight for 18 hours. After removal of THF, the residual solid was extracted with 30 mL DCM and filtered to give a clear solution. Removal of DCM gave a deep reddish-brown solid which was ground to powder with a spatula and then dried in vacuo at room temperature. The catalyst has a repeating unit of C₃₅H₃₆Cl₂N₂O₂Ti with residual solvents which are mainly THF and a trace of DCM. The Ti % was found to be 6.59% by ICP. Calculated against the theoretical Ti % of 7.53% in C₃₅H₃₆Cl₂N₂O₂Ti, the residual solvent was found to be 12.48% by weight. The catalyst yield was 1.36 g (97%).

### Example 8b

### Preparation of Catalyst MNZr-6

The title catalyst MNZr-6 was synthesized via the same procedure as MNTi-6 using ligand BFI-1 (0.5 g) and BFI-2 (0.5 g) (totally 1.0 g, 1.93 mmol) and equimolar ZrCl₄. The multi-nuclear Zr catalyst was obtained as pale yellow solid with a repeating unit of C₃₅H₃₆O₂N₂O₂Zr. The Zr % was found to be 12.18% by ICP. Calculated against the theoretical Zr % of 13.44% in C₃₄H₃₆Cl₂N₂O₂Zr, the residual solvent was found to be 9.38%. The catalyst yield was 1.40 g (97%).

### Example 9

### Preparation of Catalysts MNTi-1 and MNZr-1

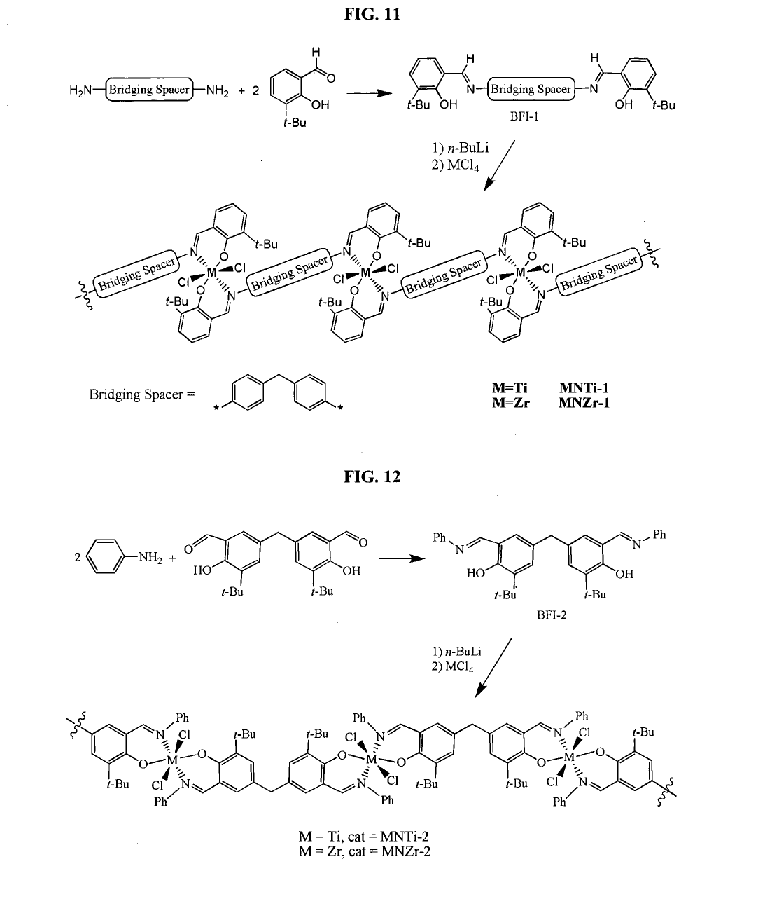

Catalysts MNTi-1 and MNZr-1 were synthesized according to the reaction scheme shown in FIG. 11.

### Example 9a

### Preparation of Catalyst MNTi-1 (Comparative Example 1)

To a stirred solution of BFI-1 (1.00 g, 1.93 mmol) in THF (20 mL), a solution of n-butyllithium (1.6M, 2.4 mL, 3.86 mmol) in hexane was added dropwise over a period of 10 minutes at −78° C. Then the mixture was allowed to warm to room temperature and stirred for two hours. The resulting solution was added dropwise to a stirred solution of TiCl₄ (0.3657 g, 1.93 mmol) in THF (15 mL) at −78° C. via a cannula over a period of 20 minutes. The resulting mixture was again warmed to room temperature and stirred overnight for 18 hours. After removal of THF, the residual solid was extracted with 30 mL DCM and filtered to give a clear solution. Removal of DCM gave a deep reddish-brown solid which was ground to powder with a spatula and then dried in vacuo at room temperature. The catalyst has a repeating unit of C₃₅H₃₆Cl₂N₂O₂Ti with residual solvent being THF and a trace of DCM. The Ti % was found to be 6.52% by ICP. Calculated against the theoretical Ti % of 7.53% in C₃₅H₃₆Cl₂N₂O₂Ti, the residual solvent was found to be 13.41% by weight. The catalyst yield was 1.35 g (95%). FT-IR (cm⁻¹): ν_{C—N}=1554 cm⁻¹, σ_{Ti—O}=498 cm⁻¹, σ_{Ti—O}=460 cm⁻¹, σ_{Ti—N}=360 cm⁻¹. Raman (cm⁻¹): ν_{C—N}=1590 and 1553 cm⁻¹, ν_{Ti—O}=889, 552 and 439 cm⁻¹, ν_{Ti—Cl}=362, ν_{Ti —N}=325 cm⁻¹.

### Example 9b

### Preparation of Catalyst MNZr-1

### Comparative Example 2

Catalyst MNZr-1 was synthesized via the same procedure as MNTi-1 using ligand BFI-1 (1.00 g, 1.93 mmol) and equimolar ZrCl₄. The multi-nuclear Zr catalyst was obtained as pale yellow solid with a repeating unit of C₃₅H₃₆Cl₂N₂O₂Zr. The Zr % was found to be 12.15%. Calculated against the theoretical Zr % of 13.44% in C₃₄H₃₆Cl₂N₂O₂Zr, the residual solvent was found to be 9.60%. The catalyst yield was 1.42 g (98%). FT-IR (cm⁻¹): ν_{C═N}=1553 cm⁻¹, ν_{Zr—O}=445 cm⁻¹, ν_{Zr—Cl}=370 cm⁻¹, ν_{Zr—N}=330 cm⁻¹.

### Example 10

### Preparation of Catalysts MNTi-2 and MNZr-2

Catalysts MNTi-2 and MNZr-2 were synthesized according to the reaction scheme shown in FIG. 12.

### Example 10a

### Synthesis of Catalysts MNTi-2

### Comparative Example 3

Catalyst MNTi-2 was synthesized via the same procedure as MNTi-1 using ligand BFI-2 (0.60 g, 1.16 mmol) in 20 mL THF and equimolar TiCl₄ in 15 mL THF. The multi-nuclear catalyst MNTi-2 was obtained as a deep reddish-brown solid with a repeating unit of C₃₅H₃₆Cl₂N₂O₂Ti. The Ti % was found to be 6.58%. Calculated against the theoretical Ti % of 7.53% in C₃₅H₃₆Cl₂N₂O₂Ti, the residual solvent was found to be 12.62%. The catalyst yield was 0.81 g (96%). FT-IR (cm⁻¹): ν_{C—N}=1551 cm⁻¹, ν_{Ti—O}=498 cm⁻¹, ν_{Ti—O}=472 cm⁻¹, ν_{Ti—N}=362 cm⁻¹.

### Example 10b

### Synthesis of Catalyst MNZr-2

### Comparative Example 4

Catalyst MNZr-2 was synthesized via the same procedure as MNTi-1 using ligand BFI-4 (0.60 g, 1.16 mmol) in 20 mL THF and equimolar TiCl₄ in 15 mL THF. The multi-nuclear catalyst MNZr-2 was obtained as a pale yellow solid with a repeating unit of C₃₅H₃₆Cl₂N₂O₂Zr. The Zr % was found to be 12.13%. Calculated against the theoretical Zr % of 13.44% in C₃₅H₃₆Cl₂N₂O₂Zr, the residual solvent was found to be 9.75%. The catalyst yield was 0.87 g (100%). FT-IR (cm⁻¹): ν_{C—N}=1551 cm⁻¹, ν_{Zr—N}=330 cm⁻¹.

### Example 11

### Preparation of Mono-Nuclear Ti Catalyst (FI—Ti)

### Comparative Example 5

(i) Preparation of Phenoxy-Imine Ligand (FI)

Aniline (1.44 g, 15.46 mmol) was dissolved into anhydrous methanol (25 mL) under stirring. Then 3-tert-butyl-2-hydroxy-benzaldehyde (2.5 g, 14.03 mmol) was added, followed by several drops of formic acid. The resulting mixture was stirred for one hour at room temperature and then refluxed for 8 h under argon atmosphere. After being cooled down to room temperature, methanol was removed under vacuum. The yellow liquid residue was purified by column chromatography eluted with hexane/ethyl acetate (10:1) affording the product as 3.2 g of a pale yellow oil (90% yield). ¹H-NMR (CDCl₃, 400 MHz, δ): 1.54 (s, 9H, tert-Butyl), 6.91-7.48 (m, 8H, aromatic-H), 8.66 (s, 1H, —CH═N—), 13.97 (s, 1H, —OH). ¹³C-NMR (CDCl₃, 100 MHz, δ): 29.39, 34.96, 118.37, 119.10, 121.23, 126.75, 129.41, 130.39, 130.71, 137.69, 148.51, 160.58, 163.42.

(ii) Preparation of Catalyst FI—Ti

Catalyst FI—Ti was synthesized via the same procedure as MNTi-1 using ligand (FI) (1.00 g, 3.95 mmol) and half an equivalent of Tiaₜ. The catalyst was obtained as a deep reddish-brown solid bearing a general formula of C₃₄H₃₆Cl₂N₂O₂Ti with residual solvent being THF and traces of DCM. The Ti % was found to be 6.69%. Calculated against the theoretical Ti % of 7.68% in C₃₄H₃₆Cl₂N₂O₂Ti, the residual solvent was found to be 12.89%. The catalyst yield was 1.34 g (95%). FT-IR (cm⁻¹): ν_{C—N}=1554 cm⁻¹, ν_{Ti—O}=500 cm⁻¹, ν_{Ti—Cl}=458 cm⁻¹, ν_{Ti—N}=365 cm⁻¹. Raman (cm⁻¹): ν_{C—N}=1586 cm⁻¹ and 1555 cm⁻¹, νTi—O=890 cm⁻¹, 558 cm⁻¹ and 446 cm⁻¹, ν_{Ti—Cl}=363 cm⁻¹, ν_{Ti—N}=336 cm⁻¹.

### Example 12

### Preparation of Mono-Nuclear Zr Catalyst (FI—Zr)

### Comparative Example 6

Catalyst FI—Zr was synthesized via the same procedure as MNTi-1 using ligand (FI) (1.00 g, 3.95 mmol) and half an equivalent of ZrCl₄. The catalyst was obtained as a pale yellow solid bearing a general formula of C₃₄H₃₆Cl₂N₂O₂Zr with residual solvent being THF and traces of DCM. The Zr % was found to be 12.18%. Calculated against the theoretical Zr % of 13.68% in C₃₄H₃₆Cl₂N₂O₂Zr, the residual solvent was found to be 10.96%. The catalyst yield was 1.40 g (95%). FT-IR (cm⁻¹): ν_{C—N}=1553 cm⁻¹, ν_{Zr—O}=445 cm⁻¹, ν_{Zr—O}=370 cm⁻¹, ν_{Zr}—N=330 cm⁻¹.

### Example 13

### Catalyst Evaluation—General Procedure for Ethylene Homo-Polymerization in 300 mL Reactor

Polymerization was carried out in a 300 mL stainless steel autoclave equipped with a mechanical stirrer with adjustable stirring rate. The autoclave was heated by a heating mantle. Before reaction, the autoclave was dried under vacuum at 100° C. for 2 hours during which period the autoclave was swept with dry argon at least three times. Then the temperature was lowered to the reaction temperature (60° C.) and the reactor was evacuated and refilled with ethylene. Hexane (100 mL), methylalumoxane (MAO) (2.0 mmol) and catalyst solution in DCM were added consecutively via syringe under ethylene atmosphere (˜10 PSI) at a stirring rate of 300 RPM. Then the autoclave was quickly pressurized to 80 PSI (5.5 bar) with ethylene and the stirring rate was adjusted to 500 RPM. After the polymerization was run for the required time, the ethylene pressure was vented quickly and the reaction was quenched with 2 mL ethanol. The produced polyethylene was collected by filtration, washed with ethanol and hexane and dried in vacuo at 50° C. The obtained white polymer was weighed and analyzed with GPC. The activity was calculated in unit of K_{gPE} mol_{M}⁻¹ h⁻¹ bar⁻¹.

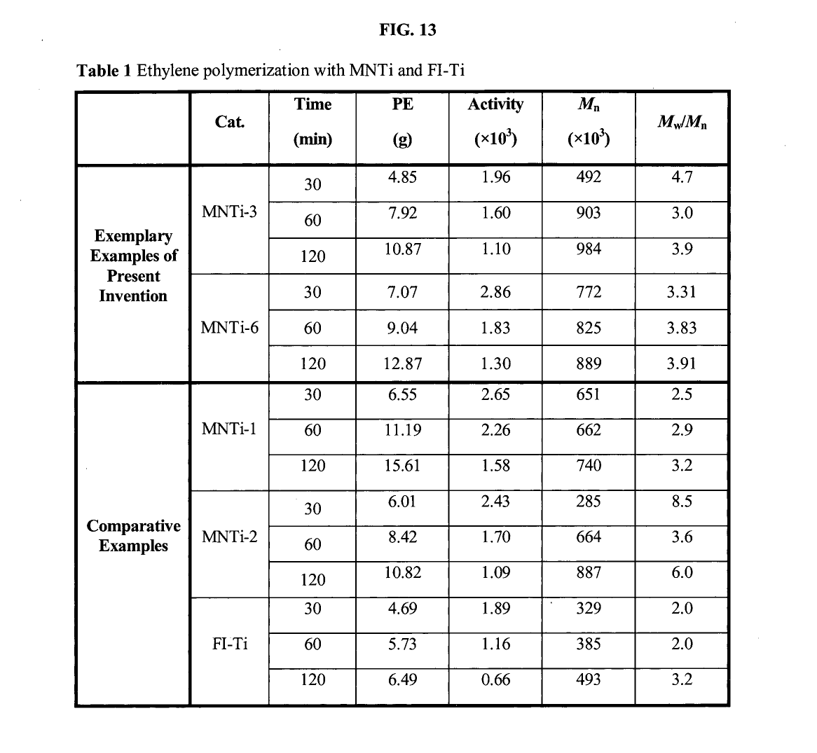

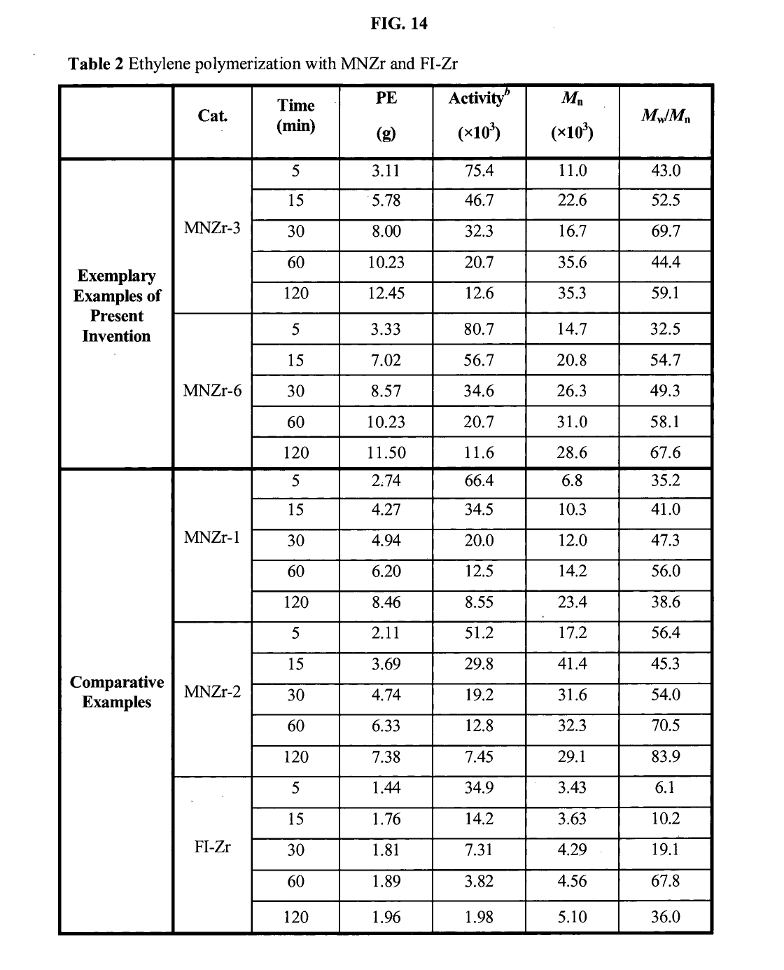

FIG. 13 is a table (Table 1) summarizing the performance of ethylene polymerization obtained using self-assembled polymerization catalysts (MNTi-3 and MNTi-6) according to embodiments of the present invention, and state of the art catalysts (MNTi-1, MNTi-2, and FI—Ti). FIG. 14 is a table (Table 2) summarizing the performance of ethylene polymerization obtained using self-assembled polymerization catalysts (MNZr-3 and MNZr-6) according to embodiments of the present invention, and state of the art catalysts (MNZr-1, MNZr-2, and FI—Zr).

### Example 14

### Catalyst Evaluation—General Procedure for Copolymerization of Ethylene and 1-Hexene in 1-L Reactor

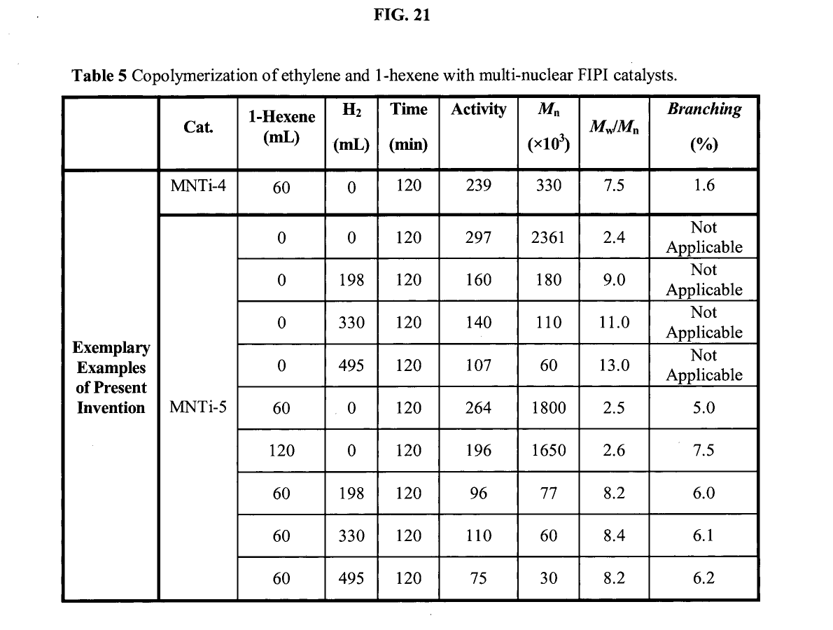

Copolymerization of ethylene and 1-hexene was carried out in a 1 L stainless steel autoclave, which was heated by recycling hot oil. The reactor was equipped with a small burette (10 mL) and a big burette (150 mL) connected in series for hydrogen and 1-hexene addition, respectively. The big one was fixed directly above the reactor. Before reaction, the autoclave was dried under vacuum at 100° C. for 4 hours during which period the autoclave was swept with dry argon at least three times. After the reactor was cooled down to room temperature, pentane (600 mL) was pressurized with Ar. Then the reactor was heated to 60° C. and desired amount of MAO was pressurized with Ar as well. The Ar pressure was controlled to about 5.0 bar at a stirring rate of 500 RPM. Varying amounts of hydrogen and 1-hexene were pressurized with ethylene, followed by the introduction of catalyst (6.0 μmol) solution in DCM (3 mL) with Ar pressure. Then ethylene was quickly pressurized into the autoclave until the total ethylene pressure reached 6.0 bar. During the polymerization process, the ethylene pressure was maintained at 6.0 bar via mass flow controller. After the polymerization was run for 2 h, the pressure was vented quickly and the reaction was quenched with 12 mL ethanol. The produced copolymer was collected by filtration, washed with ethanol and hexane and dried in vacuo at 50° C. The obtained white polymer was weighed and analyzed with GPC. The activity was calculated against the total pressure in unit of Kg_{PE} mol_{M}⁻¹ bar⁻¹. FIG. 21 is a table (Table 5) summarizing the performance of co-polymerization of ethylene and 1-hexene using self-assembled polymerization catalysts (MNTi-4 and MNTi-5) according to embodiments of the present invention.

### Example 15

### Catalyst Evaluation—Catalytic Activity and Stability

Upon activation with MAO, the multi-nuclear catalysts were evaluated for ethylene polymerization for different reaction times (see Table 1 in FIG. 13 and Table 2 in FIG. 14). From the figures, it can be seen that the multi-nuclear catalysts (MNTi-1 to MNTi-6 and MNZr-1 to MNZr-6) displayed higher activity and better stability than the corresponding mono-nuclear catalysts (FI—Ti and FI—Zr).

Referring to FIG. 13, both MNTi-3 and MNTi-6 according to embodiments of the present invention displayed 1.7 and 2.0 times higher activity, respectively, compared to that of the mono-nuclear FI—Ti catalyst at a run time of 120 minutes. In particular, MNTi-6 displayed a much higher activity of 1300 kg_{PE} mol_{M}⁻¹ h⁻¹ bar⁻¹ compared to that of the mono-nuclear FI—Ti catalyst with an activity of 660 kg_{PE} mol_{M}⁻¹ h⁻¹ bar⁻¹ for a 120 minutes run.

Referring to FIG. 14, MNZr-3 according to an embodiment of the present invention displayed a 2.2, 3.3, 4.4, 5.4, and 6.4 times higher activity at a run time of 5, 15, 30, 60 and 120 min respectively compared to that of mono-nuclear FI—Zr catalyst. MNZr-3 displayed the highest activity among the four multi-nuclear catalysts MNZr-6, MNZr-1, MNZr-2 and MNZr-3. For example, at a run time of 120 min, the cumulative activity of MNZr-3 was 1.5 and 1.7 times higher than for MNZr-1 and MNZr-2. At this run time, MNZr-3 displayed an extremely high activity up to 12600 kg_{PE} mol_{M}⁻¹ h⁻¹ bar⁻¹.

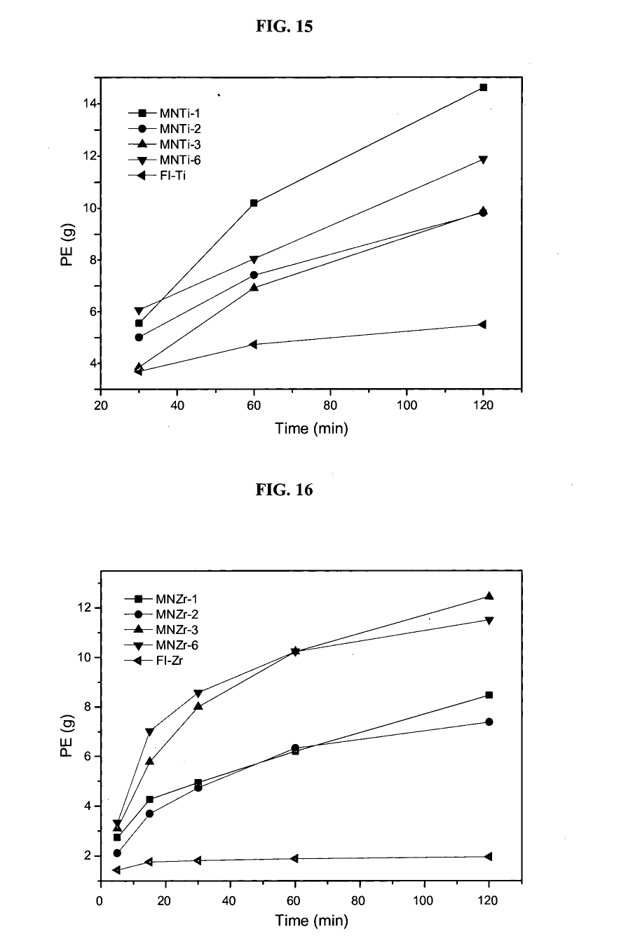

The amount of polyethylene (PE, g) obtained using the self-assembled polymerization catalysts (MNTi-3 and MNTi-6) according to embodiments of the present invention, and state of the art catalysts (MNTi-1, MNTi-2, and FI—Ti) are plotted with time and shown in FIG. 15. FIG. 17 are photographs showing the amounts of polymer produced after several reaction times of (i) 30 minutes, (ii) 60 minutes and (iii) 120 minutes using (A) MNTi-3, (B) MNTi-6 and (C) state of the art catalyst FI—Ti. From these figures, it can be seen that for both MNTi-3 and MNTi-6, the amount of polyethylene (PE) increased quickly with an increase in reaction time while for FI—Ti, the amount of polyethylene produced increased very slowly.

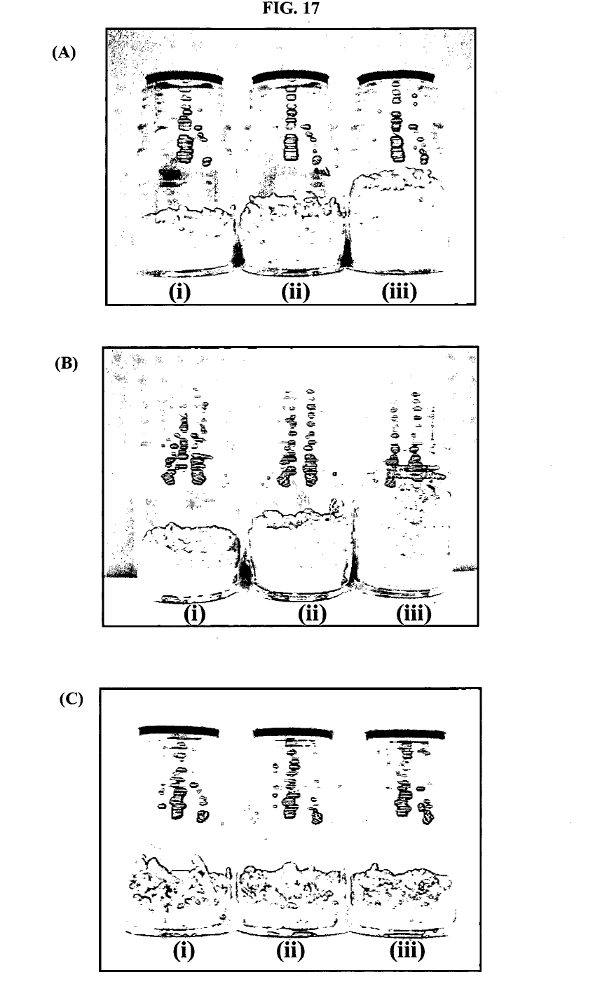

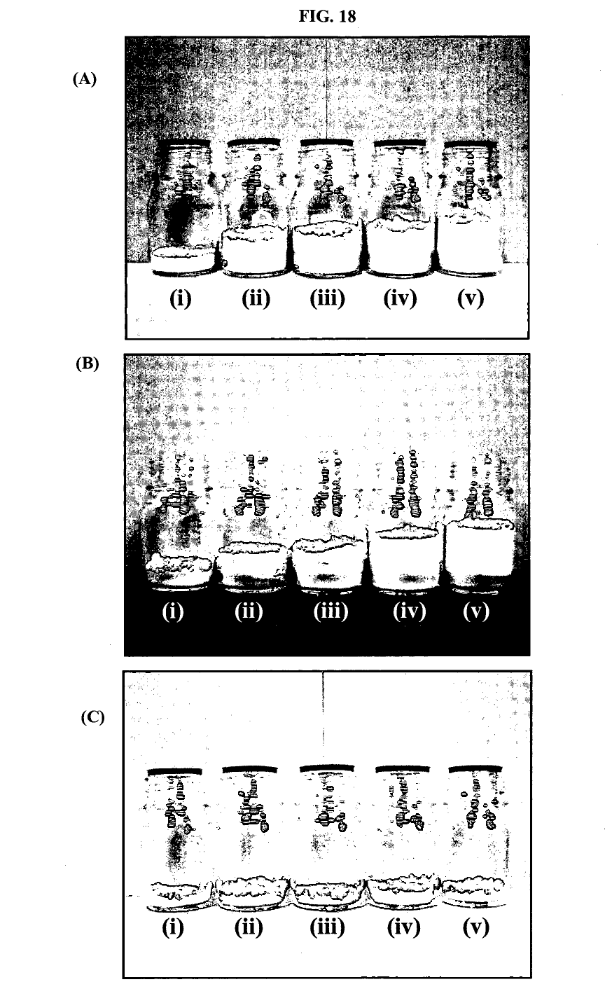

FIG. 16 is a corresponding graph comparing the amount of polyethylene obtained (PE, g) with time (“productivity comparison”) for MNZr-3 and MNZr-6 and state of the art catalysts MNZr-1, MNZr-2, and FI—Zr. FIG. 18 are photographs showing the amounts of polymer produced after several reaction times of (i) 5 minutes, (ii) 15 minutes, (iii) 30 minutes, (iv) 60 minutes and (v) 120 minutes using (A) MNZr-3, (B) MNZr-6 and (C) state of the art catalyst FI—Zr. From the figures, it can be seen that the amount of polyethylene (PE) produced increased quickly with an increase in reaction time for both MNZr-3 and MNZr-6, while for FI—Zr, the amount of polyethylene obtained increased very slowly.

### Example 16

### Catalyst Evaluation—Molecular Weight (MW)

Industry catalysts produce high molecular weight (MW) polymers that is used in making final products in the markets, such as films, packing materials and tubes etc. For most of the non-metallocene single-site catalysts, one main problem is that the polymer produced has too low MW. It is useful that, besides being more active and stable, all the multi-nuclear catalysts produced polyethylene of higher MW compared to the mono-nuclear catalysts (see Table 1 in FIG. 13 and Table 2 in FIG. 14).

Referring to FIG. 13, the obtained Mₙ for the catalyst MNTi-3 are 492×10³, 903×10³ and 984×10³ at run times of 30 min, 60 min and 120 min respectively, all of which are higher than the corresponding values of 329×10³, 385×10³ and 493×10³ for FI—Ti.

Referring to FIG. 14, the obtained Mₙ for the catalyst MNZr-3 are 11.0×10³, 22.6×10³, 16.7×10³, 35.6×10³ and 35.3×10³ at run times of 5 min, 15 min, 30 min, 60 min and 120 min respectively, all of which are higher the corresponding values of 3.43×10³, 3.63×10³, 4.29×10³, 4.56×10³ and 5.10×10³ for FI—Zr.

### Example 17

### Catalyst Evaluation—Comparison of Metal Coordination Surroundings

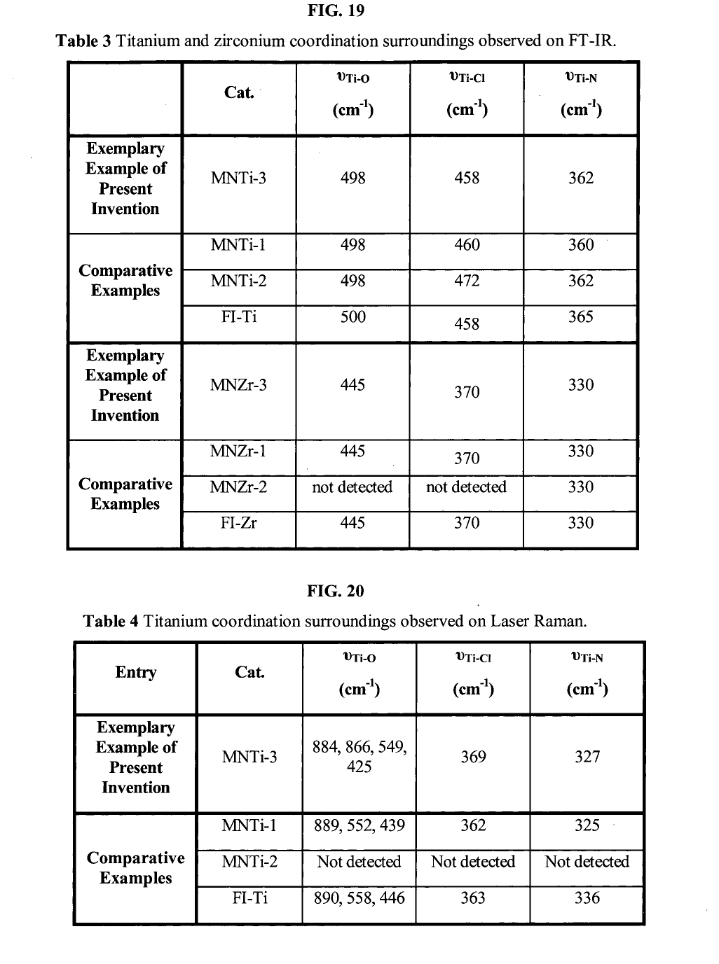

Catalysts MNTi-1 to MNTi-3 and MNZr-1 to MNZr-3 were characterized with FT-IR and Laser-Raman, and compared with FI—Ti and FI—Zr. FIG. 19 is a table (Table 3) summarizing the FTIR readings of MNTi-3 and MNZr-3, and state of the art catalysts MNTi-1, MNTi-2, FI—Ti, MNZr-1, MNZr-2, and FI—Zr. FIG. 20 is a table (Table 4) summarizing the Laser Raman readings of MNTi-3, and state of the art catalysts MNTi-1, MNTi-2, and FI—Ti.

The results indicate that, compared to FI—Ti and FI—Zr, the multi-nuclear catalysts (Ti or Zr) have similar active sites that displayed higher activity and longer lifetime because of the self-assembly strategy.

### Example 18

### Catalyst Evaluation—Multi-Nuclear Catalysts with Hetero Coordination Units

The phenoxy-imine based catalysts, including various multi-nuclear catalysts and mono-nuclear catalysts, are not able to copolymerize ethylene with 1-hexene very well. To overcome this problem, a second ligand, the bis-pyrrolide-imine ligand was used to replace the bis-phenoxy-imine in the second self-assembly step, hence forming a multi-nuclear FIPI catalyst. Bis-pyrrolide-imine is a smaller ligand as compared to bis-phenoxy-imine. Therefore the obtained catalyst may still have sufficient space to allow 1-hexene to approach the central metal, thus offering the opportunity for 1-hexene to be incorporated into the polyethylene backbone.

The experimental results showed that the multinuclear catalyst MNTi-4 produced a copolymer of ethylene and 1-hexene with 1.6% branching. The fluorine-containing multinuclear catalyst MNTi-5 can increase the branching to 5.0% under identical conditions. When the amount of 1-hexene was increased from 60 mL to 120 mL, the branching was further increased to 7.5% (see Table 5 of FIG. 21). On the other hand, MNTi-5 also has good hydrogen response. For both the homopolymerization of ethylene and copolymerization of ethylene with 1-hexene, the Mn decreased gradually with the increase of the amount of hydrogen. This provides an easy way to regulate the molecular weight for practical applications.

### Example 19

### Direct Use of Catalyst After Synthesized

Catalyst purifications via re-crystallization or wash with solvents generally lose much catalyst resulting in low yields and high operation cost in catalyst production. For practical applications, all the bis-ligands and metals employed should be used in the catalyst. In the present invention, all the catalysts were used directly after synthesized without further purification. Ti % can be found by ICP to calculate the catalyst loading. Solvent residue (THF) in the catalyst can be removed by excess Al(III) in MAO, because Al(III) in MAO is a stronger Lewis acid than Ti(IV) in the catalyst. Hence the catalyst can fully display its catalytic capabilities for olefin polymerization. The examples show that all the invention multinuclear catalysts demonstrated high activities, producing polyethylene with high molecular weight.

The advantages exemplified in above can meet the requirements of industrial applications. Therefore this family of self-assembled catalysts demonstrates the potential to compete with multi-site Ziegler-Natta catalysts and Group-4 metal metallocene catalysts.

1-40. (canceled)

41. A self-assembled olefin polymerization catalyst comprising a transition metal complex according to formula (I)
A-[(L²(MXₙ)ₚ(MXₙ-L¹(MXₙ)_{q}-MXₙ—B)ᵣ-MXₙ)_{y}-(L¹(MXₙ)ₜ(MXₙ-L²(MXₙ)ᵤ-MXₙ-A′)ᵥMXₙ)_{w}]_{z}—B (I)
wherein
each M is independently a transition metal selected from the group consisting of Group 3-11 of the periodic table;
each X is independently selected from the group consisting of H, halogen, CN, optionally substituted N(R^{a})₂, OH, optionally substituted C₁-C₂₀ alkyl, optionally substituted C₁-C₂₀ alkoxy, wherein R^{a} is independently selected from the group consisting of optionally substituted C₁-C₂₀ alkyl, optionally substituted C₆-C₂₀ aryl and halogen;
A is nothing, L¹(MXₙ)_{g}MXₙ—, or MXₙL¹(MXₙ)_{g}MX_{n,}—;
A′ is nothing, -L¹(MXₙ)_{g}MXₙ, or -L¹(MXₙ)_{g,};
B is nothing, -L²(MXₙ)ₕ or -L²(MXₙ)ₕMXₙ;
g is 0 or an integer of at least 1;
h is 0 or an integer of at least 1;
p is 0 or an integer of at least 1;
q is 0 or an integer of at least 1;
r is 0 or an integer of at least 1;
t is 0 or an integer of at least 1;
u is 0 or an integer of at least 1;
v is 0 or an integer of at least 1;
w is an integer of at least 1;
y is an integer of at least 1;
z is an integer of at least 1;
n is an integer selected from 0-6, wherein n is selected depending on the valency of M such that the net charge of each M nucleus is zero or all ligand binding positions of M are occupied;
L¹ and L² are independently selected ligands, wherein L¹ and L² are different, wherein said L¹ and L² are independently selected ligands having the following formula (10 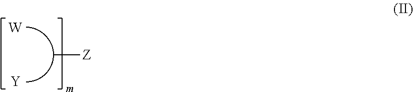
wherein
each WY unit forms a coordination unit;
m is an integer of at least 2;
Z is a bridging spacer selected from the group consisting of hydrocarbons having about 2 to about 100 carbon atoms and hetero-hydrocarbons having about 2 to about 100 carbon atoms, wherein Z has a size, length and angle so that each coordination units WY binds to a different transition metal atom;
each W and Y is independently a metal-coordinating moiety selected from the group consisting of a carbene, an optionally substituted C₅-C₂₀aryl, and metal-coordinating groups comprising an oxygen atom, a sulphur atom, a selenium atom, a nitrogen atom, or a phosphorus atom in neutral or charged form;
wherein the semi-circle in the WY unit represents an optionally substituted hydrocarbon, hetero-hydrocarbon or Si-containing backbone to which the metal-coordinating moieties W and Y are bonded.

42. The self-assembled olefin polymerization catalyst according to claim 41, wherein the optionally substituted hydrocarbon, hetero-hydrocarbon or Si-containing backbone to which the metal-coordinating moieties W and Y are bonded is selected from the group consisting of an optionally substituted C₆-C₂₀ aryl group, an optionally substituted C₆-C₂₀ heteroaryl group and an optionally substituted Si group.

43. The self-assembled olefin polymerization catalyst according to claim 41, wherein said WY unit is selected from the group consisting of 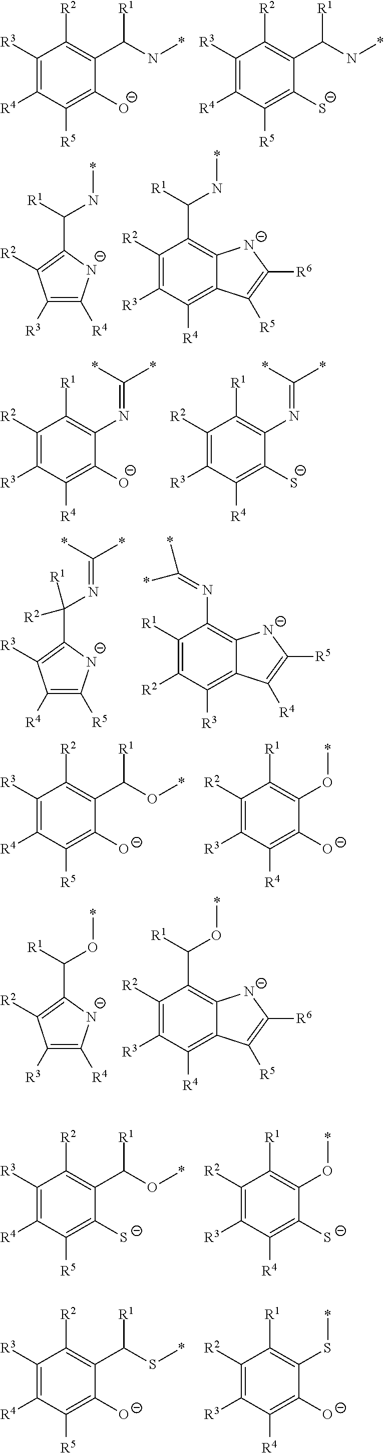 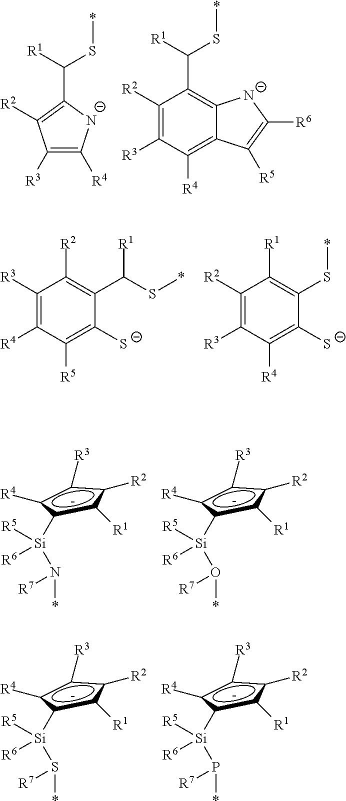
wherein
R¹, R², R³, R⁴, R⁵, R⁶, and R⁷ may be the same or different and are each selected from the group consisting of H, optionally substituted straight-chain or branched C₁-C₂₀ alkyl, optionally substituted straight-chain or branched C₂-C₂₀ alkenyl, optionally substituted straight-chain or branched C₂-C₂₀ alkynyl, optionally substituted C₆-C₂₀ aryl, optionally substituted C₆-C₂₀ heteroaryl, halogen, OH, NO₂, and CN, wherein two or more of R¹ to R⁷ may be bonded to each other to form a ring.

44. The self-assembled olefin polymerization catalyst according to claim 41, wherein Z is selected from the group consisting of an optionally substituted C₃-C₁₀ alicyclic group, an optionally substituted C₆-C₂₀ aryl group, an optionally substituted C₆-C₂₀ heteroaryl group, a system of condensed nucleus and a system of two, three or four optionally substituted C₅-C₂₀ aryl groups being connected via a N-atom, a Si-atom, an C₁-C₂₀ alkyl group, an C₂-C₂₀ alkenyl group or an C₆-C₂₀ aryl group.

45. The self-assembled olefin polymerization catalyst according to claim 44, wherein Z is a bis-linker selected from the group consisting of 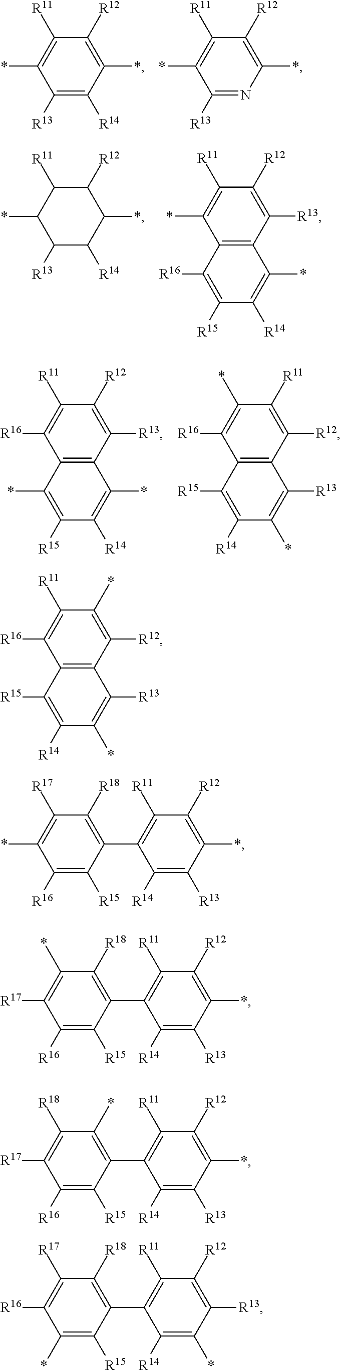 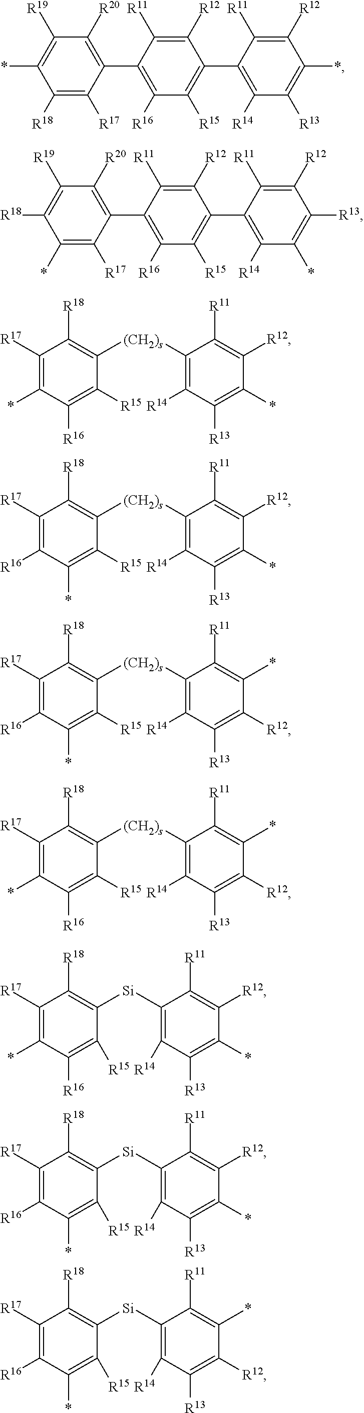 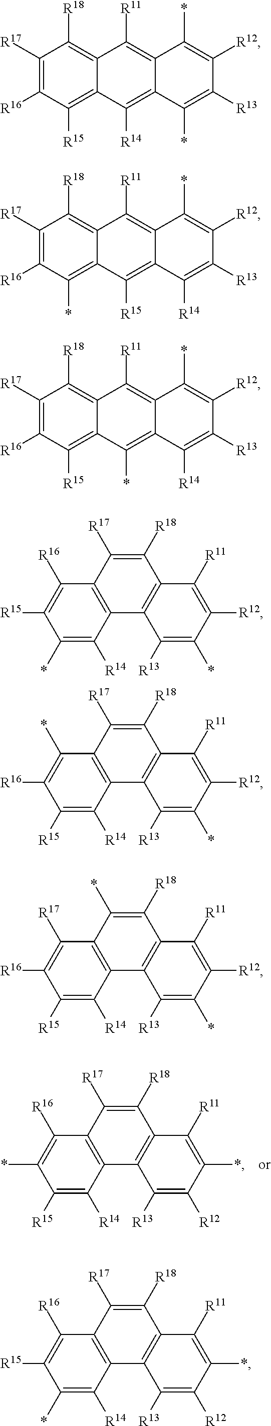
wherein R¹¹ to R²⁰ may be the same or different and are each selected from the group consisting of H, optionally substituted straight-chain or branched C₁-C₂₀ alkyl, optionally substituted straight-chain or branched C₂-C₂₀ alkenyl, optionally substituted straight-chain or branched C₂-C₂₀ alkynyl, optionally substituted C₆-C₂₀ aryl, optionally substituted C₆-C₂₀ heteroaryl, halogen, OH, NO₂, and CN, wherein two or more of R¹¹ to R²⁰ may be bonded to each other to form a ring and s is an integer from 1 to 20.

46. The self-assembled olefin polymerization catalyst according to claim 44, wherein Z is a tri-linker selected from the group consisting of 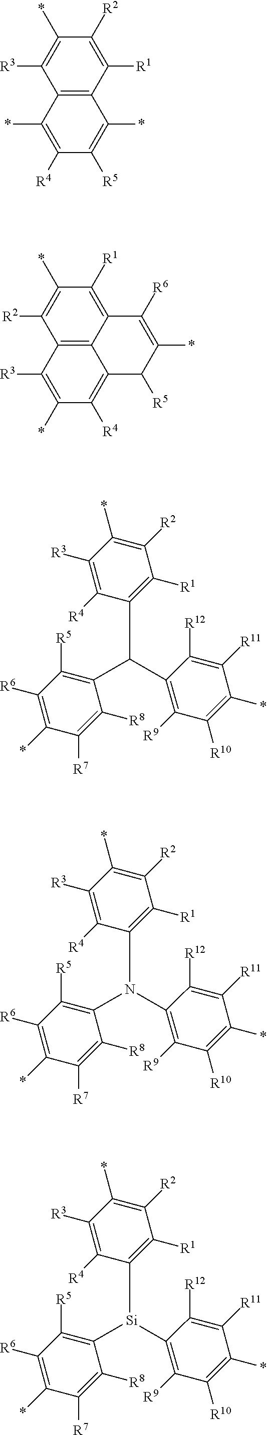 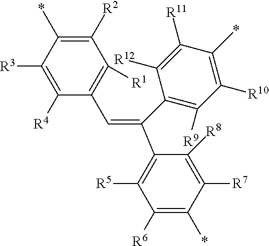
wherein R⁸-R¹² may be the same or different and are each selected from the group consisting of H, optionally substituted straight-chain or branched C₁-C₂₀ alkyl, optionally substituted straight-chain or branched C₂-C₂₀ alkenyl, optionally substituted straight-chain or branched C₂-C₂₀ alkynyl, optionally substituted C₆-C₂₀ aryl, optionally substituted C₆-C₂₀ heteroaryl, halogen, OH, NO₂, and CN, wherein two or more of R⁸ to R¹² may be bonded to each other to form a ring.

47. The self-assembled olefin polymerization catalyst according to claim 44, wherein Z is a tetrakis-linker selected from the group consisting of 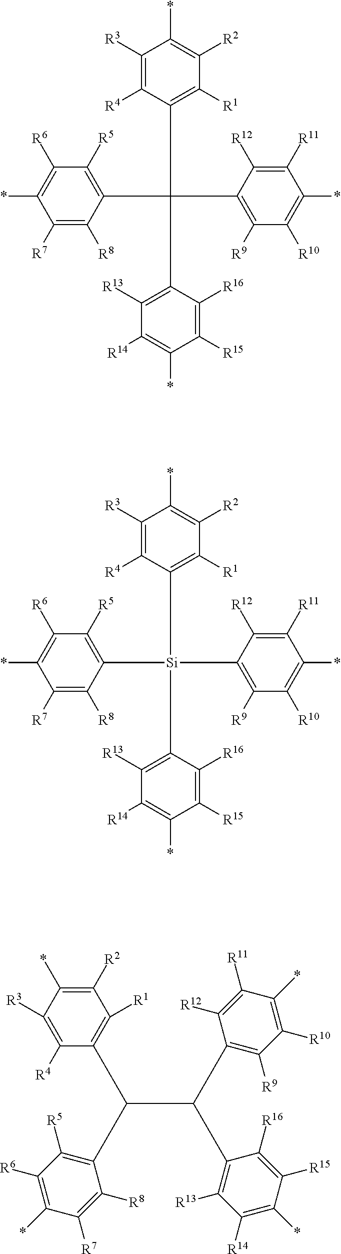 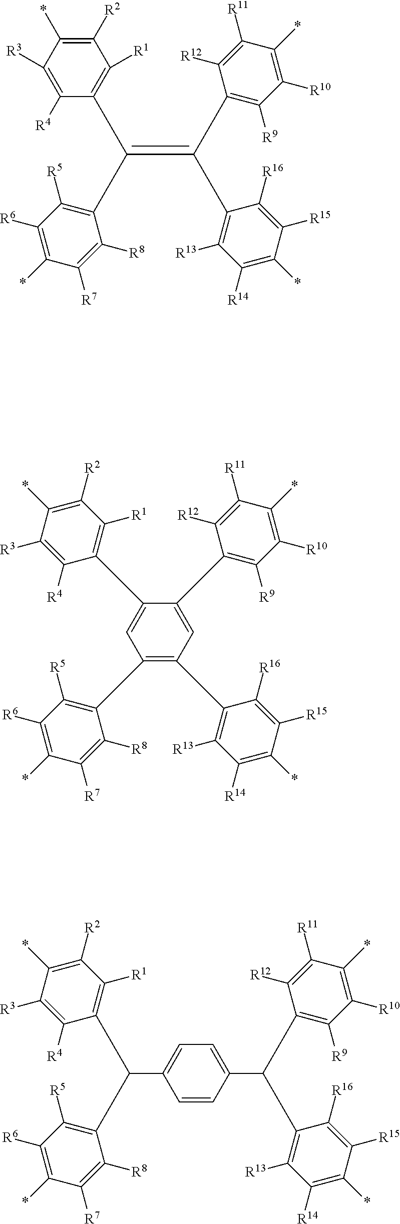
wherein R⁸-R¹⁶ may be the same or different and are each selected from the group consisting of H, optionally substituted straight-chain or branched C₁-C₂₀ alkyl, optionally substituted straight-chain or branched C₂-C₂₀ alkenyl, optionally substituted straight-chain or branched C₂-C₂₀ alkynyl, optionally substituted C₆-C₂₀ aryl, optionally substituted C₆-C₂₀ heteroaryl, halogen, OH, NO₂, and CN, wherein two or more of R⁸ to R¹⁶ may be bonded to each other to form a ring.

48. The self-assembled olefin polymerization catalyst according to claim 41, wherein each of the ligands L¹ and L² are independently selected from the group consisting of 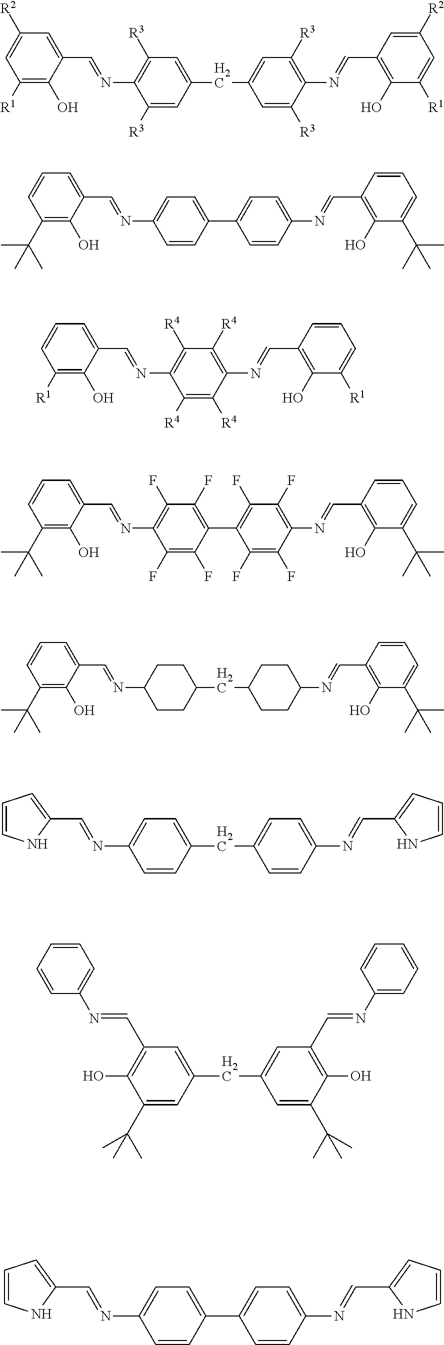 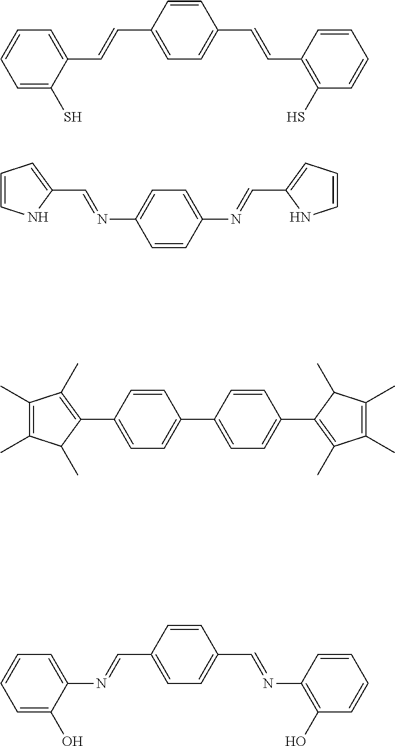
wherein
R¹, R², R³ and R⁴ may be the same or different and are each selected from the group consisting of H, optionally substituted straight-chain or branched C₁-C₂₀ alkyl, optionally substituted straight-chain or branched C₂-C₂₀ alkenyl, optionally substituted straight-chain or branched C₂-C₂₀ alkynyl, optionally substituted C₆-C₂₀ aryl, optionally substituted C₆-C₂₀ heteroaryl, halogen, OH, NO₂, and CN, wherein two or more of R¹ to R⁴ may be bonded to each other to form a ring.

49. The self-assembled olefin polymerization catalyst according to claim 41, wherein the molar ratio of coordination unit WY to metal is about 0.5:1 to about 6:1.

50. The self-assembled olefin polymerization catalyst according to claim 41, wherein the transition metals are selected from the group consisting of Sc, Y, La, Ti, Zr, Hf, V, Nb, Ta, Sm, Yb, Cr, Mo, W, Mn, Tc, R^{e}, Fe, Ru, Os, Co, Rh, Ir, Ni, Pd, Pt, Cu, Zn and mixtures thereof.

51. The self-assembled olefin polymerization catalyst according to claim 41, further comprising a solid support.

52. The self-assembled olefin polymerization catalyst according to claim 41, wherein the catalyst forms a 3-Dimensional organometallic framework.

53. The self-assembled olefin polymerization catalyst according to claim 41, wherein the catalyst forms a linear assembling structure.

54. The self-assembled olefin polymerization catalyst according to claim 41, wherein the catalyst forms a macrocyclic assembling structure containing at least two metal centres.

55. The self-assembled olefin polymerization catalyst according to claim 41, further comprising at least one co-catalyst selected from the group consisting of an organometallic compound, an organoaluminum oxy-compound, and an ionizing ionic compound.

56. The self-assembled olefin polymerization catalyst according to claim 41, wherein g=h=p=q=r=t=u=v=0, w=y=z=1, A=A′=B=nothing, wherein the catalyst has the formula (III)
L²MXₙL¹MXₙ (III)

57. The self-assembled olefin polymerization catalyst according to claim 41, wherein the catalyst comprises one or more of the units 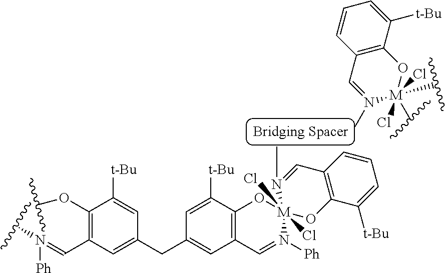
wherein the bridging spacer is 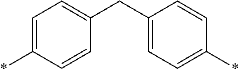 [SMILES: *c1ccc(Cc2ccc(*)cc2)cc1]
and M is Ti or Zr.

58. The self-assembled olefin polymerization catalyst according to claim 41, wherein the catalyst comprises one or more of the units 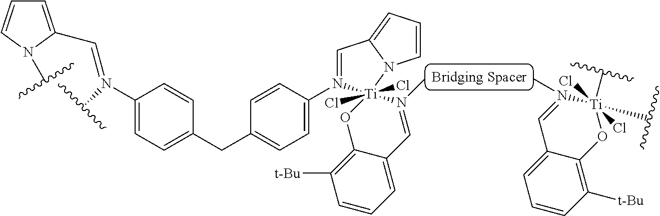
wherein the bridging spacer is 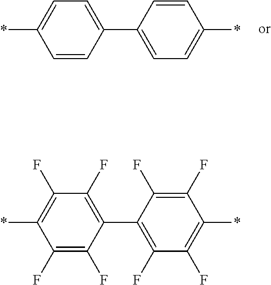 [SMILES: *c1ccc(-c2ccc(*)cc2)cc1 ; "or" ; *c1c(F)c(F)c(-c2c(F)c(F)c(*)c(F)c2F)c(F)c1F]
and M is Ti.

59. A process for polymerization or copolymerization of an olefin or a mixture of olefins in the presence of a self-assembled olefin polymerization catalyst comprising a transition metal complex according to formula (I)
A-[(L²(MXₙ)ₚ(MXₙ-L¹(MXₙ)_{q}-MXₙ—B)ᵣ-MXₙ)_{y}-(L¹(MXₙ)ₜ(MXₙ-L²(MXₙ)ᵤ-MXₙ-A′)ᵥMXₙ)_{w}]_{z}—B (I)
wherein
each M is independently a transition metal selected from the group consisting of Group 3-11 of the periodic table;
each X is independently selected from the group consisting of H, halogen, CN, optionally substituted N(R^{a})₂, OH, optionally substituted C₁-C₂₀ alkyl, optionally substituted C₁-C₂₀ alkoxy, wherein R^{a} is independently selected from the group consisting of optionally substituted C₁-C₂₀ alkyl, optionally substituted C₆-C₂₀ aryl and halogen;
A is nothing, L¹(MXₙ)_{g}MXₙ—, or MXₙL¹(MXₙ)_{g}MX_{n,}—;
A′ is nothing, -L¹(MXₙ)_{g}MXₙ, or -L¹(MXₙ)_{g,};
B is nothing, -L²(MXₙ)ₕ or -L²(MXₙ)ₕMXₙ;
g is 0 or an integer of at least 1;
h is 0 or an integer of at least 1;
p is 0 or an integer of at least 1;
q is 0 or an integer of at least 1;
r is 0 or an integer of at least 1;
t is 0 or an integer of at least 1;
u is 0 or an integer of at least 1;
v is 0 or an integer of at least 1;
w is an integer of at least 1;
y is an integer of at least 1;
z is an integer of at least 1;
n is an integer selected from 0-6, wherein n is selected depending on the valency of M such that the net charge of each M nucleus is zero or all ligand binding positions of M are occupied;
L¹ and L² are independently selected ligands, wherein L¹ and L² are different, wherein said L¹ and L² are independently selected ligands having the following formula (II) 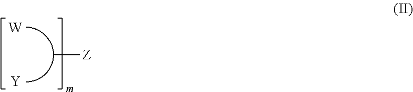
wherein
each WY unit forms a coordination unit;
m is an integer of at least 2;
Z is a bridging spacer selected from the group consisting of hydrocarbons having about 2 to about 100 carbon atoms and hetero-hydrocarbons having about 2 to about 100 carbon atoms, wherein Z has a size, length and angle so that each coordination units WY binds to a different transition metal atom;
each W and Y is independently a metal-coordinating moiety selected from the group consisting of a carbene, an optionally substituted C₅-C₂₀ aryl, and metal-coordinating groups comprising an oxygen atom, a sulphur atom, a selenium atom, a nitrogen atom, or a phosphorus atom in neutral or charged form;
wherein the semi-circle in the WY unit represents an optionally substituted hydrocarbon, hetero-hydrocarbon or Si-containing backbone to which the metal-coordinating moieties W and Y are bonded.

60. The process according to claim 59, wherein the process is carried out at a catalyst:co-catalyst mole ratio of about 1:1 to about 1:5000.
